(19) United States
(12) Patent Application Publication
(10) Pub. No.: US 2006/0159797 A1
(43) Pub. Date: Jul. 20, 2006

(54) Apparatus and method of molding preforms having a crystalline neck

(76) Inventors: Robert A. Lee, Bowdon Cheshire (GB); Gerald A. Hutchinson, Coto De Caza, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/255,765

(22) Filed: Oct. 21, 2005

Related U.S. Application Data
(60) Provisional application No. 60/621,414, filed on Oct. 22, 2004.

(51) Int. Cl. B29C 49/00

(52) U.S. Cl. 425/525; 425/526; 425/528

(57) ABSTRACT

Disclosed is a preferred apparatus and method of molding preforms having a crystalline or semi-crystalline neck finish. The apparatus is an injection mold for producing preforms, which are then molded into plastic bottles and containers, such as for containing beverages and the like.

### RELATED APPLICATIONS

This application claims the priority benefit under 35 U.S.C. § 119(e) of the provisional application 60/621,414, filed Oct. 22, 2004, which is hereby incorporated by reference in its entirety.

### BACKGROUND OF THE INVENTION

1. Field of the Invention

This invention relates to molds for producing preforms, which are then molded into plastic bottles and containers, such as for containing beverages and the like. More specifically, this invention relates to an improved mold design for producing preforms with a crystalline or semi-crystalline neck finish.

2. Description of the Related Art

The use of plastic containers as a replacement for glass or metal containers in the packaging of beverages has become increasingly popular. The advantages of plastic packaging include lighter weight, decreased breakage as compared to glass, and potentially lower costs. The most common plastic used in making beverage containers today is PET. Virgin PET has been approved by the FDA for use in contact with foodstuffs. Containers made of PET are transparent, thin-walled, lightweight, and have the ability to maintain their shape by withstanding the force exerted on the walls of the container by pressurized contents, such as carbonated beverages. PET resins are also fairly inexpensive and easy to process.

Most PET bottles are made by a process which includes the blow-molding of plastic preforms which have been made by processes including injection molding. In some circumstances, it is preferred that the PET material in plastic preforms is in an amorphous or semi-crystalline state because materials in this state can be readily blow-molded where fully crystalline materials generally cannot. However, bottles made entirely of amorphous or semi-crystalline PET may not have enough dimensional stability during a standard hot-fill process due to the relatively low glass transition temperature, Tg, of the PET material and the tight tolerances required when using standard threaded closures. In these circumstances, a bottle comprising crystalline PET would be preferred, as it would hold its shape during hot-fill processes. Unfortunately, typical preforms may have a microstructure that is not suitable for blow molding or hot fill.

### SUMMARY OF THE INVENTION

In one embodiment, a mold has a core section and cavity section. A void space is defined by the core section and cavity section when the core section and cavity section are in a closed position. The core section has a core holder holding a mandrel or core disposed within an associated mold cavity of the cavity section. In one arrangement, the heated region of the core molds the neck finish of the preform thereby producing a crystalline or semi-crystalline neck finish. The portion of the core molding the body of the preform is cooled to produce a generally amorphous body portion of the preform. In some embodiments, the core holder comprises high heat transfer material adapted to transfer heat produced by a temperature control system to the core.

In another embodiment, a mold comprises a core section and a cavity section. The core section has a core holder adapted to hold a mandrel disposed within an associated mold cavity of the cavity section. A temperature control system is adapted to heat or cool the core holder. The core holder is configured to mold at least a portion of the preform formed in the mold. The core holder can mold and cause crystallization of a portion the neck finish of a preform. In one arrangement, the core holder has a neck molding portion that extends along the core and defines a neck molding surface for molding an interior surface of a neck finish of a preform.

In some embodiments, an apparatus for molding a preform comprises a core section that has an elongated molding assembly configured to mold at least a portion of the preform. The elongated molding assembly comprises a first portion for molding a first portion of the preform. A first temperature control system is in thermal communication with the first portion. A second portion of the elongated molding assembly is configured to mold a second portion of the preform. A second temperature control system is in thermal communication with the second portion. The apparatus further comprises a cavity section that has a cavity. The cavity section and the core section mate to form a cavity space in the shape of the preform. The cavity space is positioned between the elongated molding assembly and the cavity. The first temperature control system actively controls the temperature of the first portion and the second temperature control system actively controls the temperature of the second portion such that the first portion is at a first temperature for forming crystallized material of the preform while the second portion is at a second temperature for forming substantially amorphous material of the preform.

In some embodiments, a mold assembly for molding a preform comprises a first mold half that has an elongated molding assembly for molding an interior portion of a preform. The elongated molding assembly has a first portion and a second portion. The first portion defines a first molding surface and the second portion defines a second molding surface. A second mold half has a cavity molding surface. A mold temperature control system is also provided. A mold cavity is defined by the first portion, the second portion, and the cavity molding surface. The mold temperature control system is configured to actively maintain the first portion at a temperature for forming crystalline material while actively maintaining the second portion at another temperature for forming amorphous material.

In yet other embodiments, a method of making a preform comprises injecting a material into a cavity formed by a mold section and a core section. The core section comprises a core neck finish portion for molding an inner surface of a preform and a core body portion for molding another inner surface of the preform. The core neck finish portion is maintained at a first temperature and the core body portion at a second temperature. The first temperature is greater than the crystallinity temperature of the material and the second temperature is less than the crystallinity temperature of the material. The method further comprises leaving the material in contact with the core section to form the preform having a body portion that is primarily amorphous or semi-crystalline and a neck finish that is primarily crystalline.

In some embodiments, a mold assembly for molding a preform with a crystalline neck finish is provided. The mold assembly comprises a core section having an elongated molding assembly for molding an interior portion of a preform. The elongated molding assembly has a neck finish molding portion and a body molding portion. A cavity section has a cavity molding surface. The mold assembly also comprises at least one temperature control system. A mold cavity is defined by the neck finish molding portion, the body molding portion, and the cavity molding surface. The at least one temperature control system is configured to actively maintain the neck finish molding portion at a temperature for forming crystalline material while actively maintaining the body portion at another temperature for forming amorphous material.

### BRIEF DESCRIPTION OF THE DRAWINGS

FIG. 1 is a preform having a semi-crystalline or crystalline neck finish.

FIG. 2 is a cross-sectional view of the preform of FIG. 1.

FIG. 2A is an enlarged cross-section of the neck finish of the preform of FIG. 2 taken along 2A-2A.

FIG. 2B is an enlarged cross-section of another embodiment of the neck finish of the preform of FIG. 2 taken along 2A-2A in accordance with another embodiment.

FIG. 2C is an enlarged cross-section of another embodiment of the neck finish of the preform of FIG. 2 taken along 2A-2A.

FIG. 2D is an enlarged cross-section of another embodiment of the neck finish of the preform of FIG. 2 taken along 2A-2A.

FIG. 2E is an enlarged cross-section of another embodiment of the neck finish of the preform of FIG. 2 taken along 2A-2A.

FIG. 3 is a cross-section of one preferred embodiment of barrier-coated preform.

FIG. 4 is a cross-section of another preferred embodiment of a multilayer preform.

FIG. 5 is a cross-section of a preferred preform in the cavity of a blow-molding apparatus of a type that may be used to make a preferred multilayer container.

FIG. 6 is a side view of one preferred embodiment of multilayer container.

FIG. 7 is a cross-section of an injection mold of a type that may be used to make a preferred multilayer preform.

FIGS. 8 and 9 are two halves of a molding machine to make multilayer preforms.

FIGS. 10 and 11 are two halves of a molding machine to make forty-eight two-layer preforms.

FIG. 12 is a perspective view of a schematic of a mold with mandrels partially located within the molding cavities.

FIG. 13 is a perspective view of a mold with mandrels fully withdrawn from the molding cavities, prior to rotation.

FIG. 14 is a cross-sectional view of a three-layer embodiment of a preform.

FIG. 15 is a cross-section of an injection mold of a type that may be used to make a monolayer preform.

FIG. 16 is a cross-section of the mold of FIG. 15 taken along lines 16-16.

FIG. 17 is a cutaway close up view of the area of FIG. 15 defined by line 17.

FIG. 18 is a cross-section of an injection mold core having a double wall neck finish portion.

FIG. 19 is a cross-section of an enhanced injection mold core having a high heat transfer base end portion.

FIG. 20 is a cross-section of yet another injection mold utilizing a combination of hardened material components and high heat transfer material components.

FIG. 21 is a cross-section of an injection mold having a temperature controlled core holder for producing crystalline or semi-crystalline neck finishes.

FIG. 21A is an enlarged cross-sectional view of portion of a core and the core holder of FIG. 21 taken along 21A-21A.

FIG. 21B is a cross-sectional view of an injection mold for producing crystalline or semi-crystalline neck finishes.

FIG. 21C is an enlarged cross-sectional view of portion of a core and a core holder of FIG. 21B taken along 21C-21C.

FIG. 22 is a cross-section of yet another injection mold having a temperature controlled core holder for producing crystalline or semi-crystalline neck finishes.

FIG. 23 is an enlarged cross sectional view of portion of the injection mold of FIG. 22 taken along 23-23.

### DETAILED DESCRIPTION OF THE PREFERRED EMBODIMENT

Disclosed herein are various methods and apparatuses for producing articles having semi-crystalline and/or crystalline material. In one non-limiting exemplary embodiment, at least a portion of an article is adapted to contact food or liquid and comprises a formable material, such as PET, that may impart substantially no flavor to the food or liquid. For example, the article can be a preform, a container, a closure, a closure liner, and the like. The containers can be in the form of a bottle, jar, tube, food container, cup or other container suitable for holding foods, fluids, or other items. However, for the sake of simplicity, these embodiments will be described herein primarily as articles or by an individual article name. It is to be understood in many cases that other articles may be substituted for the named article.

The preferred embodiments described herein generally produce preforms with a semi-crystalline crystalline neck finish, which are typically then blow-molded into containers. The preforms may be monolayer; that is, the preforms can be comprised of a single layer of a base material, or they may be multilayer, including, but not limited to, those which comprise a combination of a base material and an outer material (e.g., a barrier layer, recycled PET, and the like). The material in such layers may be a single material or it may be a blend of one or more materials so as to include blends of polymers and/or inclusion of one or more oxygen scavenging materials. The provision of one or more barrier layers, or the inclusion of one or more oxygen scavengers in one or more layers, is generally desirable when the container is to be filled with a carbonated beverage or oxygen sensitive product. The barrier layer serves to prevent the ingress of oxygen into the container or the egress of carbon dioxide from the container. Additionally, multiple barrier layers may be provided to refine barrier properties or provide desirable structural properties.

By achieving a crystallized state in the neck portion of the preform before blow molding or hot-filling, the final dimensions of the neck portion of a container are substantially identical to the initial dimensions of the preform. Therefore, dimensional variations are minimized and dimensional stability is achieved during and/or after the preform is processed. Additionally, this results in reduced dimensions variations of the threads on the neck finish.

The preforms may have both substantially crystalline and substantially amorphous or substantially semi-crystalline regions. A preform which has both crystalline and amorphous or semi-crystalline regions is shown in U.S. Pat. No. 6,217,818 to Collete et al. However, the preform of Collete et al. is constructed using a separately formed crystalline neck portion, which is then placed into a second cavity which forms an amorphous body portion of the preform.

While a non-crystalline body portion preform is preferred for blow-molding, a bottle having greater crystalline character in the neck portion is preferred for its dimensional stability during a hot-fill process. Accordingly, a preform constructed according to preferred embodiments has a generally non-crystalline body portion and a generally crystalline neck portion. To create generally crystalline and generally non-crystalline portions in the same preform, different levels of heating and/or cooling can be used during the molding process to achieve the desired preform microstructure. The different levels of heating and/or cooling are preferably maintained by thermal isolation of the injection mold. For example, thermal isolation between the thread split, core and/or cavity interface can be accomplished utilizing a combination of energy sources, cooling mandrels, mold materials and other suitable devices.

At least one of the preferred preforms is provided with a barrier layer. As such, the description may often refer to a multilayer preform or finished bottle. References to multilayer preform, however, should not give the impression that the present disclosure is confined only to multilayer preforms and containers which comprise a base layer of PET and a second layer or barrier coating; monolayer preforms comprised of homopolymers or copolymers of PET or other such crystalline polymers and polyesters, multilayer preforms having more than two layers, preforms having at least one layer comprising recycled PET (“RPET”), and other such permutations including the materials noted above may also be made to have the crystallized thread and/or neck components described herein.

Furthermore, the embodiments described herein specifically describe use of polyethylene terephthalate (PET) but many other thermoplastics, including those of the polyester type may also be used. Examples of such other materials include polyethylene naphthalate (PEN), PETG, polytetramethylene 1,2-dioxybenzoate, copolymers of ethylene terephthalate and ethylene isophthalate, and Polyamide Blends, and recycled materials, such as RPET.

In especially preferred embodiments, “high IPA PET” is used as the polyester which is multilayer. As it is used herein, the term “high-IPA PET” refers to PET to which IPA was added during to manufacture to form a copolymer in which the IPA content is more than about 2% by weight, preferably 2-10% IPA by weight, more preferably 3-8%, most preferably about 4-5% IPA by weight. The most preferred range is based upon current FDA regulations, which do not allow for PET materials having an IPA content of more than 5% to be in contact with food or drink. If such regulations are not a concern, then an IPA content of 5-10% is preferred. As used herein, “PET” includes “high IPA PET.”

The high-IPA PET (more than about 2% by weight) is preferred because the inventor has surprisingly discovered that use of high-IPA PET in the processes for making barrier preforms and containers, provides for better interlayer adhesion than is found in those laminates comprising PET with no IPA or low IPA. Additionally, it has been found that interlayer adhesion improves as the IPA content rises. Incorporation of the higher amounts of IPA into the PET results in a decrease in the rate of crystallization of the high IPA PET material as compared to PET homopolymer, or PET having lower amounts of IPA. The decrease in the rate of crystallization allows for the production of PET layers (made of high IPA PET) having a lower level of crystallinity than what is achieved with low-IPA PET or homopolymer PET when they are made into barrier preforms by similar procedures. The lower crystallinity of the high-IPA PET is important in reducing crystallinity at the surface of the PET, i.e. the interface between the PET and the barrier material. Lower crystallinity allows for better adhesion between the layers and also provides for a more transparent container following blow molding of the preform.

The cooling of the mold in regions which form preform surfaces for which it is preferred that the material be generally amorphous or semi-crystalline, is accomplished by chilled fluid circulating through the mold cavity and core. In preferred embodiments, a mold set-up similar to conventional injection molding applications is used, except that there is an independent fluid circuit or electric heating system for the portions of the mold from which crystalline portions of the preform will be formed. Other energy sources can be used for controlling the temperature of the preforms.

Preferably, the preforms and containers have the coating disposed on their outer surfaces or within the wall of the container. Adhesion between the layers results without the use of any additional materials such as an adhesive material or a tie layer. The coated preforms are processed, preferably by stretch blow molding, to form bottles using methods and conditions similar to those used for uncoated preforms. The containers which result are strong, resistant to creep, shrinkage and are cosmetically appealing as well as having good gas-barrier properties.

One or more layers of a material are employed in carrying out the methods of making the articles according to preferred embodiments. As used herein, the terms “barrier material”, “barrier resin” and the like refer to materials which, when used to form articles, preferably have key physical properties similar to PET, adhere well to PET, and have a lower permeability to oxygen and carbon dioxide than PET.

Once a suitable barrier material is chosen, an apparatus and method for economically manufacturing a container using the barrier material can be chosen. One method and apparatus involves using an injection molding machine in conjunction with a mold comprising a mandrel or core and a cavity. A first layer of a preform is molded between the mandrel and a first cavity of the mold when a molten polyester is injected therein. The first layer remains on the mandrel when the mandrel is pulled out of the cavity, moved, and inserted into a second mold cavity. A second layer of material, preferably a barrier layer or a layer comprising barrier material, is then injected over the existing first preform layer. The mandrel and accompanying preform are then removed from the second cavity and a robot removes the preform from the mandrel. While the robot cools the molded preform, the mandrel is available for another molding cycle.

A number of barrier materials having the requisite low permeability to gases such as oxygen and carbon dioxide are useful in preferred embodiments, the choice of barrier material being partly dependent upon the mode or application as described below. Preferred barrier materials for use in barrier coatings include those which fall into two major categories: (1) copolyesters of terephthalic acid, isophthalic acid, and at least one diol having good barrier properties as compared to PET, such as those disclosed in U.S. Pat. No. 4,578,295 to Jabarin, and which is commercially available as B-010 (Mitsui Petrochemical Ind. Ltd., Japan); and (2) hydroxy-functional poly(amide-ethers) such as those described in U.S. Pat. Nos. 5,089,588 and 5,143,998, poly(hydroxy amide ethers) such as those described in U.S. Pat. No. 5,134,218, polyethers such as those described in U.S. Pat. Nos. 5,115,075 and 5,218,075, hydroxy-functional polyethers such as those as described in U.S. Pat. No. 5,164,472, hydroxy-functional poly(ether sulfonamides) such as those described in U.S. Pat. No. 5,149,768, poly(hydroxy ester ethers) such as those described in U.S. Pat. No. 5,171,820, hydroxy-phenoxyether polymers such as those described in U.S. Pat. No. 5,814,373, and poly(hydroxyamino ethers) (“PHAE”) such as those described in U.S. Pat. No. 5,275,853. The barrier materials described in (1) above are referred to herein by the term “Copolyester Barrier Materials”. The compounds described in the patents in (2) above are collectively categorized and referred to herein by the term “Phenoxy-type Thermoplastic” materials. All the patents referenced in this paragraph are hereby incorporated in their entireties into this disclosure by this reference thereto.

Preferred Copolyester Barrier Materials have FDA approval. FDA approval allows for these materials to be used in containers where they are in contact with beverages and the like which are intended for human consumption. To the inventor's knowledge, none of the Phenoxy-type Thermoplastics have FDA approval as of the date of this disclosure. Thus, these materials are preferably used in multi-layered containers in locations that do not directly contact the contents, if the contents are ingestible, or the mouth of the consumer when drinking from the container.

In carrying out preferred methods to form multilayer preforms and bottles, an initial preform is coated with at least one additional layer of material comprising barrier material, polyesters such as PET, post-consumer or recycled PET (collectively recycled PET), and/or other compatible thermoplastic materials. A coating layer may comprise a single material, a mix or blend of materials (heterogeneous or homogeneous), an interwoven matrix of two or more materials, or a plurality of microlayers (lamellae) comprised of at least two different materials. Initial preforms preferably comprise polyester, preferably virgin materials which are approved by the FDA for being in contact with foodstuffs.

Thus the preforms and containers according to preferred embodiments may exist in several forms, including, but not limited to: virgin PET coated with a layer of barrier material; virgin PET coated with a layer of material comprising alternating microlayers of barrier material and recycled PET; virgin PET coated with a barrier layer which is in turn coated with recycled PET; microlayers of virgin PET and a barrier material coated with a layer of recycled PET; virgin PET having an oxygen scavenger therein coated with recycled PET (RPET), virgin PET having an oxygen scavenger therein coated with recycled PET (RPET) which is coated with a layer of barrier material, or virgin PET coated with recycled PET which is then coated with barrier material. Other such variations and permutations of layer and material combinations are also within the scope of the disclosure and are presently contemplated.

As described previously, preferred barrier materials include Copolyester Barrier Materials and Phenoxy-type Thermoplastics. Other preferred barrier materials include polyamide barrier materials such as Nylon MXD-6 from Mitsubishi Gas Chemical (Japan). Other preferred barrier materials, referred to herein as “Polyamide Blends.” Polyamide Blends as used herein shall include those polyamides containing PET or other polyesters, whether such polyester was included by blending, compounding or reacting. Other barrier materials having similar properties may be used in lieu of these barrier materials. For example, the barrier material may take the form of other thermoplastic polymers, such as acrylic resins including polyacrylonitrile polymers, acrylonitrile styrene copolymers, polyamides, polyethylene naphthalate (PEN), PEN copolymers, and PET/PEN blends.

Preferred barrier materials in accordance with embodiments of the present invention have oxygen and carbon dioxide permeabilities which are less than one-third those of polyethylene terephthalate. For example, the Copolyester Barrier Materials preferably exhibit a permeability to oxygen of about 11 cc mil/100 in² day and a permeability to carbon dioxide of about 2 cc mil/100 in² day. For certain PHAEs, the permeability to oxygen is less than 1 cc mil/100 in² day and the permeability to carbon dioxide is 3.9 cc mil/100 in² day. The corresponding CO₂ permeability of polyethylene terephthalate, whether in the recycled or virgin form, is about 12-20 cc mil/100 in² day.

For embodiments in which the container is heat set during or after blow-molding, it is preferred that the materials which form the container or article can exist in a form which is at least partially crystalline, more preferably primarily crystalline. Accordingly, for such embodiments, preferred barrier materials include PEN, Copolyesters, Polyamide Blends, and Phenoxy-type Thermoplastics which can exist in partially crystalline or primarily crystalline form.

The methods of preferred embodiments provide for a coating to be placed on a preform which is later blown into a bottle. In many cases, such methods are preferable to placing coatings on the bottles themselves. However, in accordance with other preferred embodiments, one or more coating layers may be placed on a bottle or container itself. Preforms are smaller in size and of a more regular shape than the containers blown therefrom, making it simpler to obtain an even and regular coating. Furthermore, bottles and containers of varying shapes and sizes can be made from preforms of similar size and shape. Thus, the same equipment and processing can be used to produce preforms to form several different kinds of containers. The blow-molding may take place soon after molding, or preforms may be made and stored for later blow-molding. If the preforms are stored prior to blow-molding, their smaller size allows them to take up less space in storage.

Even though it is preferable to form containers from coated preforms as opposed to coating containers themselves, they have generally not been used because of the difficulties involved in making containers from coated or multi-layer preforms. One step where the greatest difficulties arise is during the blow-molding process to form the container from the preform. During this process, defects such as delamination of the layers, cracking or crazing of the coating, uneven coating thickness, and discontinuous coating or voids can result. These difficulties can be overcome by using suitable barrier materials and coating the preforms in a manner that allows for good adhesion between the layers.

Thus, one aspect is the choice of a suitable barrier material, for those embodiments which include barrier materials. When a suitable barrier material is used, the coating sticks directly to the preform without any significant delamination, and will continue to stick as the preform is blow-molded into a bottle and afterwards. Use of a suitable barrier material also helps to decrease the incidence of cosmetic and structural defects which can result from blow-molding containers as described above.

It should be noted that although most of the discussion, drawings, and examples of making coated preforms deal with two layer preforms or bottles incorporating barrier layers, such discussion is not intended to limit the present invention to two layer barrier articles. The disclosure should be read to include, incorporate and describe articles having one or more layers, each layer of which is independently selected from the materials disclosed herein and materials similar thereto.

The two layer barrier containers and preforms according to preferred embodiments are suitable for many uses and are cost-effective because of the economy of materials and processing steps. However, in some circumstances and for some applications, preforms consisting of more than two layers may be desired. Use of three or more layers allows for incorporation of materials such as recycled PET, which is generally less expensive than virgin PET or the preferred barrier materials. Thus, it is contemplated that all of the methods for producing the barrier-coated preforms which are disclosed herein and all other suitable methods for making such preforms may be used, either alone or in combination to produce barrier-coated preforms and containers comprised of two or more layers.

Preforms and containers, including those which incorporate RPET, may be treated with additional external coatings through dip or spray processes. The materials dipped or sprayed upon the containers or preforms include, but are not limited to, solutions or dispersions of Phenoxy-type thermoplastics.

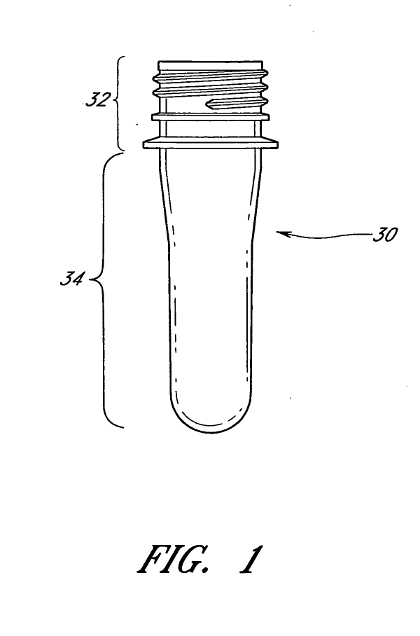

Referring to FIG. 1, a preferred preform 30 is depicted. The preform is preferably made of an FDA approved material such as virgin PET and can be of any of a wide variety of shapes and sizes. The preform shown in FIG. 1 is of the type which will form a 16 oz. carbonated beverage bottle that requires an oxygen and carbon dioxide barrier, but as will be understood by those skilled in the art, other preform configurations can be used depending upon the desired configuration, characteristics and use of the final article. The preform 30 may be made by injection molding as is known in the art or by methods disclosed herein. The preform 30 has a neck finish 32 and a body portion 34. The preform 30 can be a monolayer preform. If desired, the preform 30 can be utilized as a starting article to form a multilayer preform.

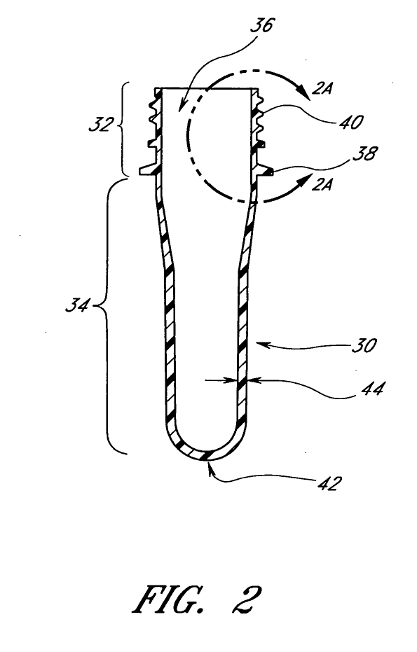

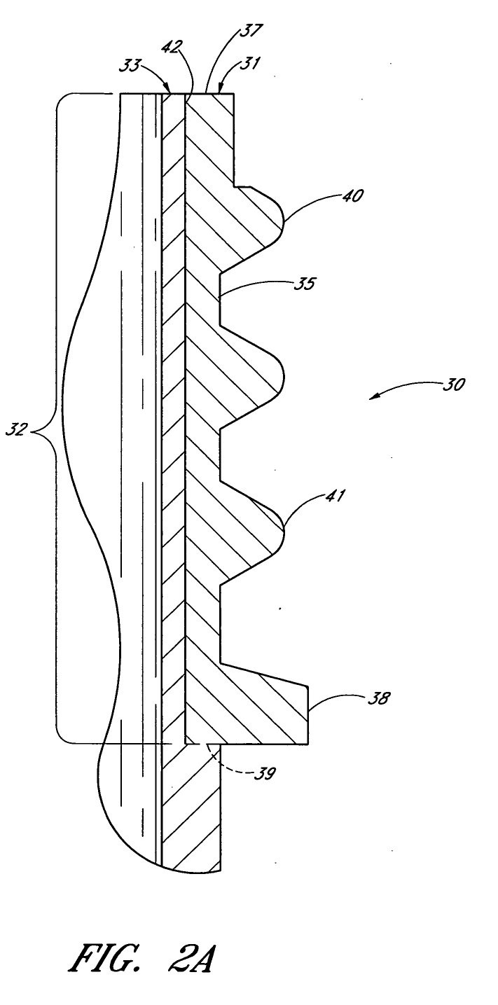

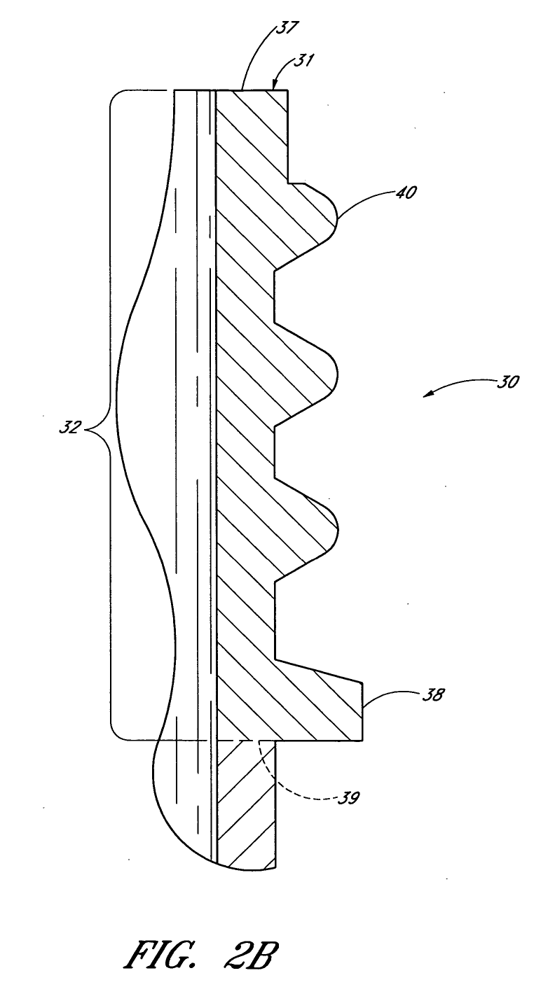

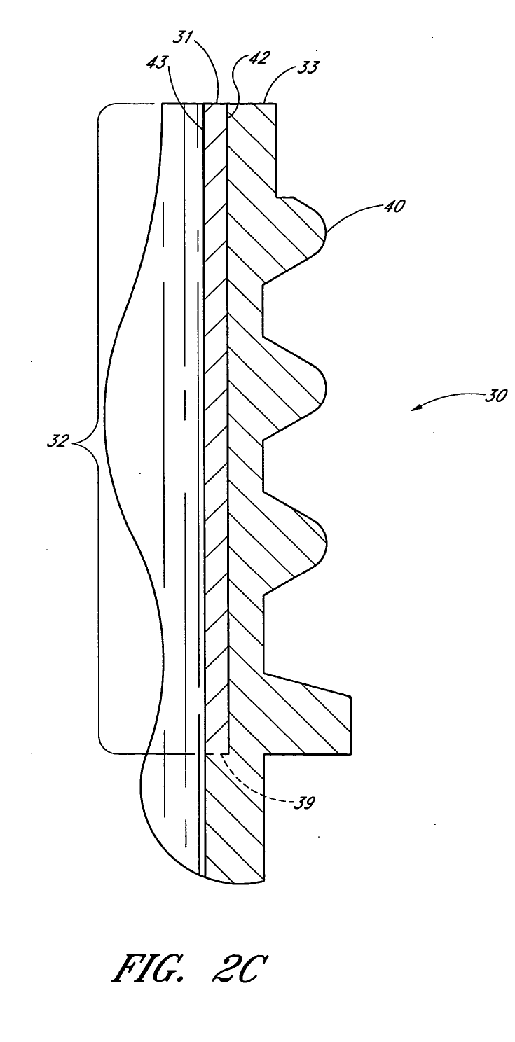

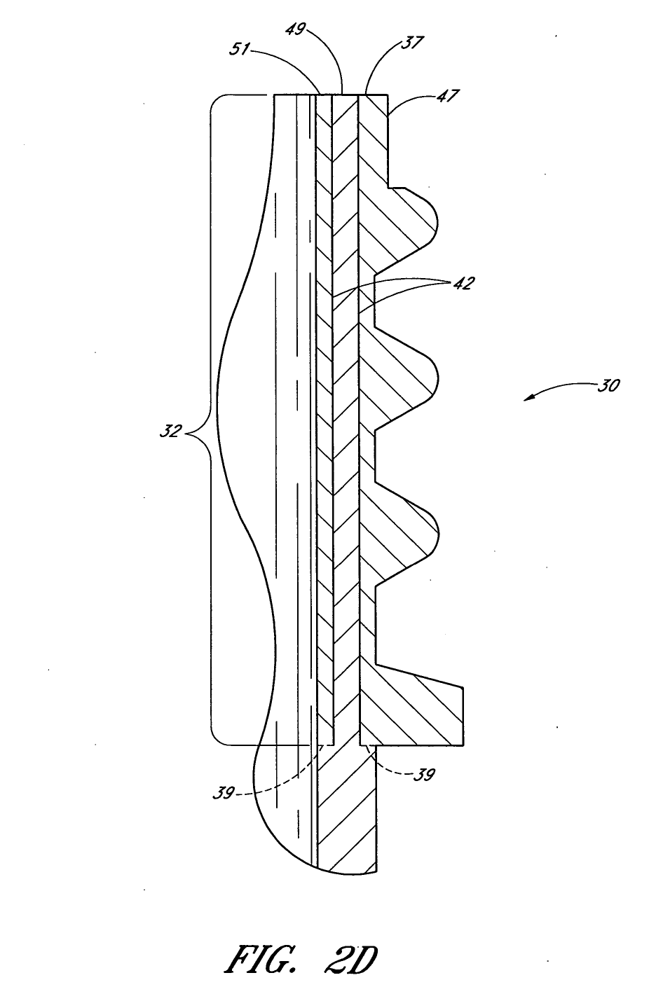

In one non-limiting exemplary embodiment, the preform 30 comprises less than about 30% by weight, also including less than about 5%, 10%, 15%, and 25% by weight, of crystalline material. The preform 30 having crystalline material can provide dimensional stability to the neck portion 32 during stretch blow molding of the body portion 34. Advantageously, the blow molding can be restricted to a primarily amorphous body portion 34 for rapid blow molding and the neck portion 32, including threads 40 (FIG. 2) and support ring 38, may generally retain its original configuration. However, in other embodiments the preform 30 can comprise more than about 30% by weight of crystalline material. In various embodiments, the preform 30 has more than about 40%, 50%, 60%, and 70%, by weight of crystalline material.

A skilled artisan can determine the appropriate configuration in size and composition of the neck portion 32 to achieve the desired properties (e.g., structural properties, thermal properties, and the like) for subsequent processing and/or end use of the container made form the preform 30. A preform having crystalline material may be especially well suited for hot fill applications.

Referring to FIGS. 2 and 2A, a cross-section of a portion of the preform 30 of FIG. 1 is depicted. The preform 30 comprises both crystalline and non-crystalline material (e.g., semi-crystalline and/or amorphous material). The terms crystalline, non-crystalline, semi-crystalline, and amorphous are broad terms and as used in accordance with their ordinary meaning. Additionally, the terms neck portion and neck finish may be used interchangeably herein and are broad terms and are also used in accordance with their ordinary meaning. The preform 30 can have any suitable amount of crystalline and non-crystalline material based on the manufacturing process and the end use of the resulting container made from the preform.

The illustrated preform 30 has the neck portion 32 that comprises crystalline material. In some embodiments, including the embodiment of FIG. 2A, the neck portion 32 comprises a first portion 31 and a second portion 33. The first portion 31 can define an outer surface 35 of the preform 30. The surface 35 can define structures 40 configured to engage a closure or cap (e.g., a crown closure, snap cap, and/or the like). The first portion 31 can extend from an upper end 37 to the support ring 38. In some embodiments, the preform 30 can have a transition portion 39 (shown schematically in phantom) that transitions between crystalline and non-crystalline material.

The first portion 31 surrounds the second portion 33 and preferably comprises crystalline material, and more preferably comprises primarily crystalline material. In some non-limiting exemplary embodiments, the first portion 31 comprises about 50% by weight, also including more than about 60%, 70%, 80%, 90%, or 95% by weight, of crystalline material. The crystalline material of the first portion 31 can be evenly or unevenly distributed throughout the neck portion 32. The first portion 31 can have any suitable amount of crystalline material based on the desired manufacturing process or a particular end use for the container made from the preform 30. The percentage of crystalline material can be increased to improve the dimensional stability of the neck finish during high temperature applications, such as hot-fill processes.

Optionally, the first portion 31 can define structures or threads 40 that preferably comprise substantially crystalline material. Thus, after the preform 30 has been blow molded, the structures or threads 40 may retain their original configuration so that they can receive a closure or cap.

The transition portion 39 can comprise material that is generally similar to the material forming the first portion 31, and preferably transitions to material that is generally similar to the material forming the body 34. In the schematic illustration of FIG. 2A, the transition portion 39 is spaced from the upper end 37 of the preform 30. In some embodiments, the transition portion 39 is located below most of the structures 40. For example, the transition portion 39 can be located below the lowest thread 41. In one embodiment, the transition portion 39 is located proximate to the support ring 38. In the illustrated embodiment, the transition portion 39 is located near the lower surface of the support ring 38. Alternatively, the transition portion 39 can be spaced below the support ring 38 at some point along the body 34.

A transition portion 42 can be located between the first portion 31 and second portion 33. The transition portion 42 can comprise material that is similar to the material of the first portion 31 and transitions to material that is similar to material forming the second portion 33. However, in other embodiments, there may not be transition portions 39 and 42.

The second portion 33 can be comprised of non-crystalline material and can form a generally uniform layer disposed between the interior of the preform 30 and the first portion 31. However, in some embodiments, a second portion 33 can have a generally non-uniform cross-section and can extend from the body 34 to the end 37. In some embodiments, the second portion 33 can comprise substantially semi-crystalline material. Alternatively, the second portion 33 can comprise substantially amorphous material. It is contemplated that one of ordinary skill in the art can determine the desired crystallinity of the second portion 33 depending on the application.

Referring to FIG. 2B, there is illustrated a cross-section of a neck portion 32 comprising substantially of crystalline material. The portion 31 of the neck portion 32 comprises primarily crystalline material. Of course, portions of the portion 31 may comprise amorphous material. However, on average the portion 31 is primarily crystalline material. The neck portion 32 illustrated in FIG. 2B may advantageously provide increased dimensional stability during the blow molding process. Additionally, bottles made from the preform 30 having a neck portion 32 comprising almost entirely of crystalline material can have enough dimensional stability for a standard hot-fill process.

Referring to FIG. 2C, the neck portion 32 comprises the first portion 31 and the second portion 33. The first portion 31 can define a portion of the interior surface 43 of the preform 30. In the illustrated embodiment, the second portion 33 comprises non-crystalline material. Preferably, the second portion 33 comprises a semi-crystalline material such that the threads or structures 40 generally retain their original shape during subsequent processing. However, in some embodiments the structures 40 may comprise mostly or entirely of amorphous material.

FIG. 2D illustrates a neck portion 32 in accordance with another preferred embodiment. The neck portion 32 comprises an outer portion 47, an intermediate portion 49, and an inner portion 51. The outer portion 47 and the inner portion 51 may comprise material that is generally similar to the material forming the first portion 31 described above. In some embodiments, the outer portion 47 and inner portion 51 comprise primarily crystalline material and can provide dimensional stability to the outer and inner surfaces of the preform 30. The intermediate portion 49 can have a greater percentage of non-crystalline material than at least one of the outer portion 47 and the inner portion 51. In some embodiments, the intermediate portion 49 can have a greater percentage of non-crystalline material than both the outer portion 47 and the inner portion 51. The thickness of the intermediate portion 49 can be reduced to increase the proportion of crystalline material forming the neck portion 32, thereby increasing the dimensional stability of the neck portion 32. The thicknesses of the outer portion 47 and the inner portion 51 can be different or generally the same as each other, if desired.

Referring to FIG. 2E, the neck portion 32 comprises the first portion 31 and the second portion 33. In the illustrated embodiment, the first portion 31 generally defines the structures 40, the end 37, and the interior surface 43 of the neck portion 32. A portion of the neck portion 32 can comprise non-crystalline material that forms the second portion 33. The second portion 33 can be disposed between a region of the first portion 31 defining the structures 40 and another region of the portion 31 defining the interior surface 43.

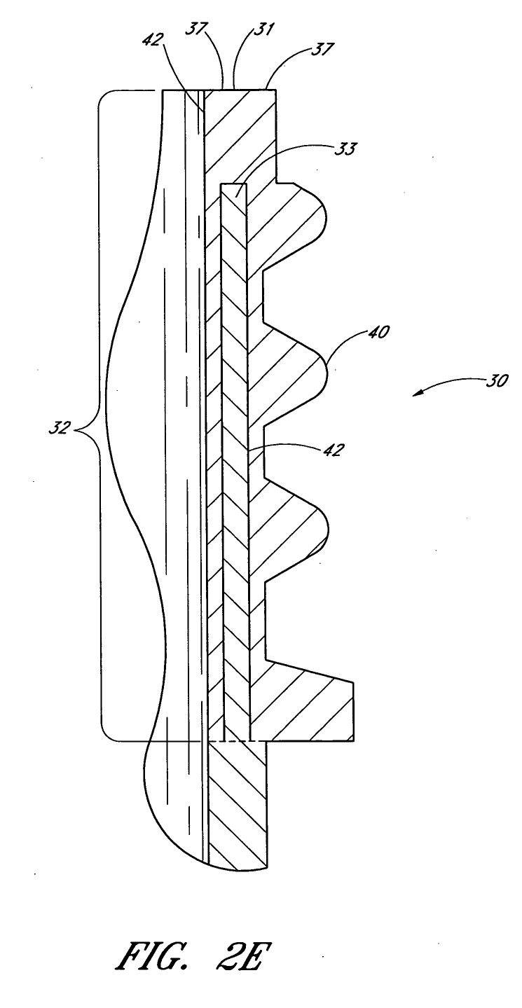

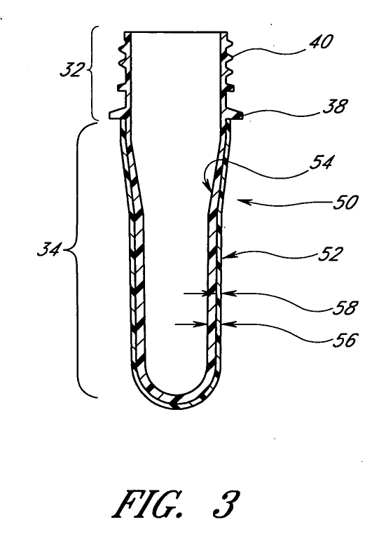

Each of the preforms illustrated in FIGS. 3 and 4, and described below, can have a neck finish 32 as described above. In some non-limiting embodiments, the preforms comprise less than about 30% by weight, also including less than about 5%, 10%, 15%, and 25%, by weight, of crystalline material. Preforms having crystalline material can provide improved tolerances to the neck portion 32 during stretch blow molding of the body portion 34. Advantageously, the blow molding can be restricted to a primarily amorphous body portion 34 for rapid blow molding while the neck portion 32, including the threads 40 and support ring 38, may generally retain its original configuration. However, in other embodiments the preforms can comprise more than about 30% by weight of crystalline material. In various embodiments, the preforms have more than about 40%, 50%, 60%, and 70% by weight of crystalline material.

With continued reference to FIG. 3, a cross-section of one type of multilayer preform 50 having features in accordance with a preferred embodiment is disclosed. The barrier-coated preform 50 has a neck portion 32 and a body portion 34 that can be similar to the preform 30 in FIGS. 1 and 2. The coating layer 52 is disposed about the entire surface of the body portion 34, terminating at the bottom of the support ring 38. A coating layer 52 in the embodiment shown in the Figure does not extend to the neck portion 32, nor is it present on the interior surface 54 of the preform which is preferably made of an FDA approved material such as PET. The coating layer 52 may comprise either a single material or several microlayers of at least two materials. The overall thickness 56 of the preform is equal to the thickness of the initial preform plus the thickness 58 of the barrier layer, and is dependent upon the overall size and desired coating thickness of the resulting container. By way of example, the wall of the bottom portion of the preform may have a thickness of 3.2 millimeters; the wall of the neck, a cross-sectional dimension of about 3 millimeters; and the barrier material applied to a thickness of about 0.3 millimeters.

Referring to FIG. 4, a preferred embodiment of a coated preform 60 is shown in cross-section. The primary difference between the coated preform 60 and the coated preform 50 in FIG. 3 is the relative thickness of the two layers in the area of the end cap 42. In coated preform 50, the barrier layer 52 is generally thinner than the thickness of the initial preform throughout the entire body portion of the preform. In coated preform 60, however, the barrier coating layer 52 is thicker at 62 near the end cap 42 than it is at 64 in the wall portion 66, and conversely, the thickness of the inner polyester layer is greater at 68 in the wall portion 66 than it is at 70, in the region of the end cap 42. This preform design is especially useful when the barrier coating is applied to the initial preform in an overmolding process to make the coated preform, as described below, where it presents certain advantages including that relating to reducing molding cycle time. These advantages will be discussed in more detail below. The barrier coating layer 52 may be homogeneous or it may be comprised of a plurality of microlayers.

The multilayer preforms and containers can have layers which have a wide variety of relative thicknesses. In view of the present disclosure, the thickness of a given layer and of the overall preform or container, whether at a given point or over the entire container, can be chosen to fit a coating process or a particular end use for the container. Furthermore, as discussed above in regard to the multilayer coating layer in FIG. 3, the multilayer coating layer in the preform and container embodiments disclosed herein may comprise a single material or several microlayers of two or more materials.

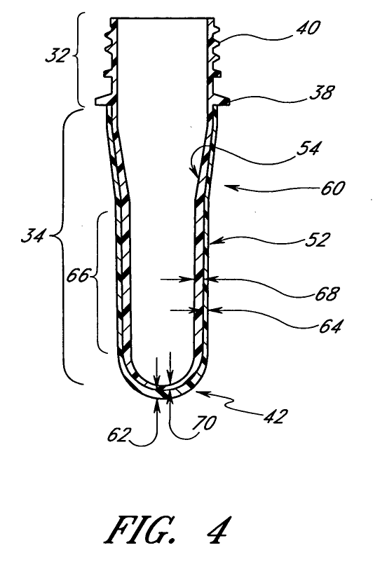

After a multilayer preform, such as that depicted in FIG. 3, is prepared by a method and apparatus such as those discussed in detail below, it is subjected to a stretch blow-molding process. Referring to FIG. 5, in this process a barrier-coated preform 50 is placed in a mold 80 having a cavity corresponding to the desired container shape. The barrier-coated preform is then heated and expanded by stretching and by air forced into the interior of the preform 50 to fill the cavity within the mold 80, creating a barrier-coated container 82. The blow molding operation normally is restricted to the body portion 34 of the preform with the neck portion 32 including the threads, pilfer ring, and support ring retaining the original configuration as in the preform.

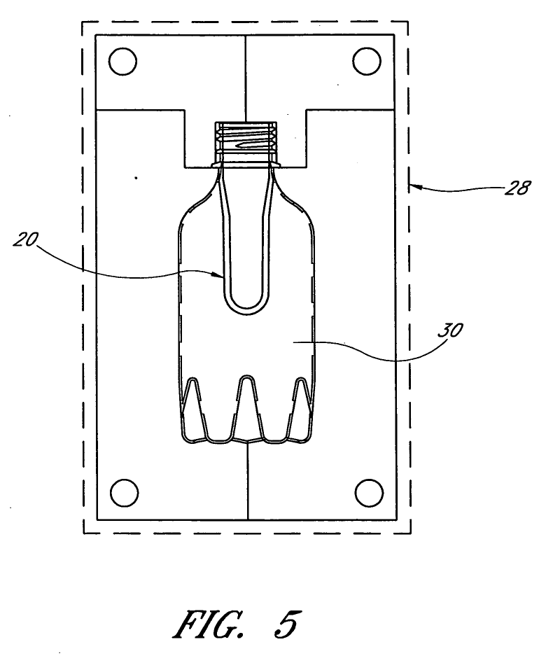

Referring to FIG. 6, there is disclosed an embodiment of multilayer container 82 in accordance with a preferred embodiment, such as that which might be made from blow molding the multilayer preform 50 of FIG. 3. The container 82 has a neck portion 32 and a body portion 34 corresponding to the neck and body portions of the barrier-coated preform 50 of FIG. 3. The neck portion 32 is further characterized by the presence of the threads 40 which provide a way to fasten a cap onto the container.

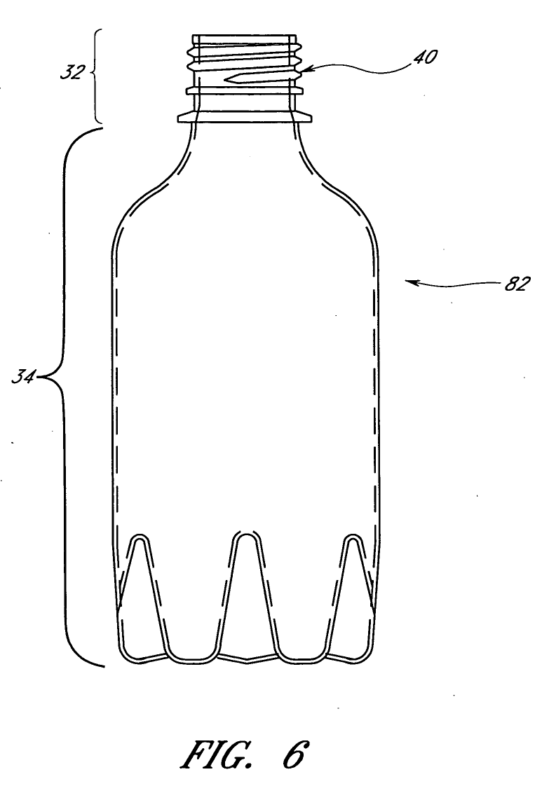

FIG. 7 illustrates a preferred type of mold for use in methods which utilize overmolding. The mold comprises two halves, a cavity half 92 and a mandrel half 94. The cavity half 92 comprises a cavity in which an uncoated preform is placed. The preform is held in place between the mandrel half 94, which exerts pressure on the top of the preform and the ledge 96 of the cavity half 92 on which the support ring 38 rests. The neck portion 32 of the preform is thus sealed off from the body portion of the preform. Inside the preform is the mandrel 98. As the preform sits in the mold, the body portion of the preform is completely surrounded by a void space 100. The preform, thus positioned, acts as an interior die mandrel in the subsequent injection procedure, in which the melt of the overmolding material is injected through the gate 102 into the void space 100 to form the coating. The melt, as well as the uncoated preform, is cooled by fluid circulating within channels 104 and 106 in the two halves of the mold. Preferably the circulation in channels 104 is completely separate from the circulation in the channels 106.

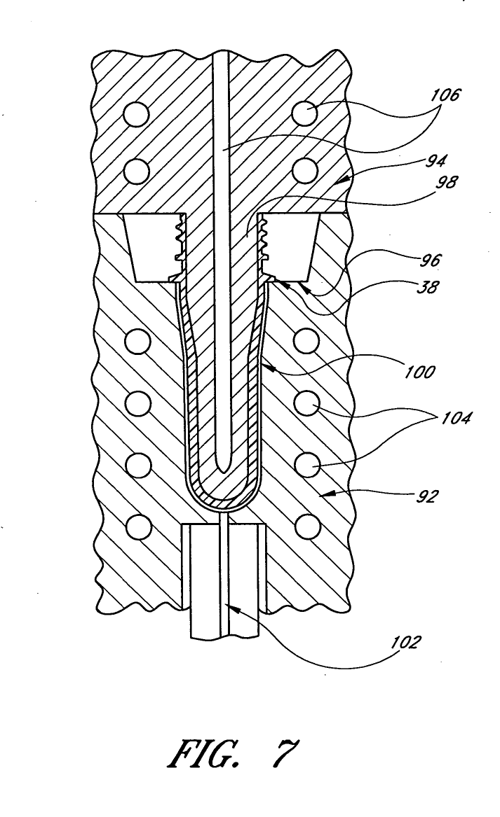

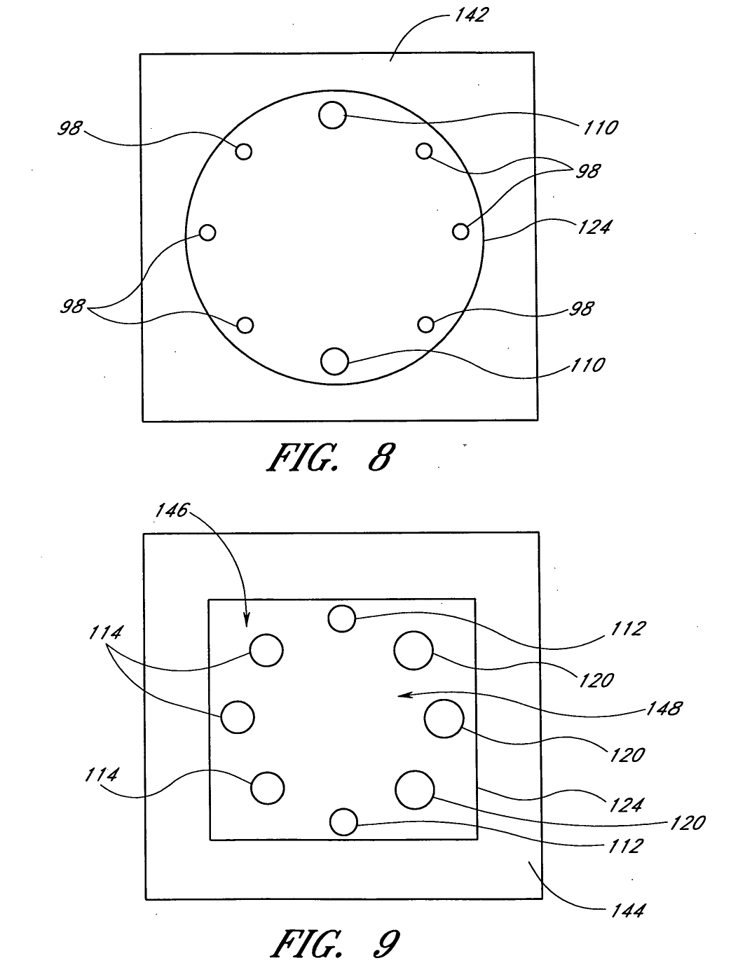

FIGS. 8 and 9 are a schematic of a portion of the preferred type of apparatus to make coated preforms in accordance with a preferred embodiment. The apparatus is an injection molding system designed to make one or more uncoated preforms and subsequently coat the newly-made preforms by over-injection of a barrier material. FIGS. 8 and 9 illustrate the two halves of the mold portion of the apparatus which will be in opposition in the molding machine. The alignment pegs 110 in FIG. 8 fit into their corresponding receptacles 112 in the other half of the mold.

The mold half depicted in FIG. 9 has several pairs of mold cavities, each cavity being similar to the mold cavity depicted in FIG. 7. The mold cavities are of two types: first injection preform molding cavities 114 and second injection preform coating cavities 120. The two types of cavities are equal in number and are preferably arranged so that all cavities of one type are on the same side of the injection block 124 as bisected by the line between the alignment peg receptacles 112. This way, every preform molding cavity 114 is 180° away from a preform coating cavity 120.

The mold half depicted in FIG. 8 has several mandrels 98, one for each mold cavity (114 and 120). When the two halves which are FIGS. 8 and 9 are put together, a mandrel 98 fits inside each cavity and serves as the mold for the interior of the preform for the preform molding cavities 114 and as a centering device for the uncoated preforms in preform coating cavities 120. The mandrels 98 are mounted on a turntable 130 which rotates 180° about its center so that a mandrel 98 originally aligned with a preform molding cavity 114 will, after rotation, be aligned with a preform coating cavity 120, and vice-versa. As described in greater detail below, this type of setup allows a preform to be molded and then coated in a two-step process using the same piece of equipment.

It should be noted that the drawings in FIGS. 8 and 9 are merely illustrative. For instance, the drawings depict an apparatus having three molding cavities 114 and three coating cavities 120 (a 3/3 cavity machine). However, the machines may have any number of cavities, as long as there are equal numbers of molding and coating cavities, for example 12/12, 24/24, 48/48 and the like. The cavities may be arranged in any suitable manner. These and other minor alterations are contemplated as part of this disclosure.

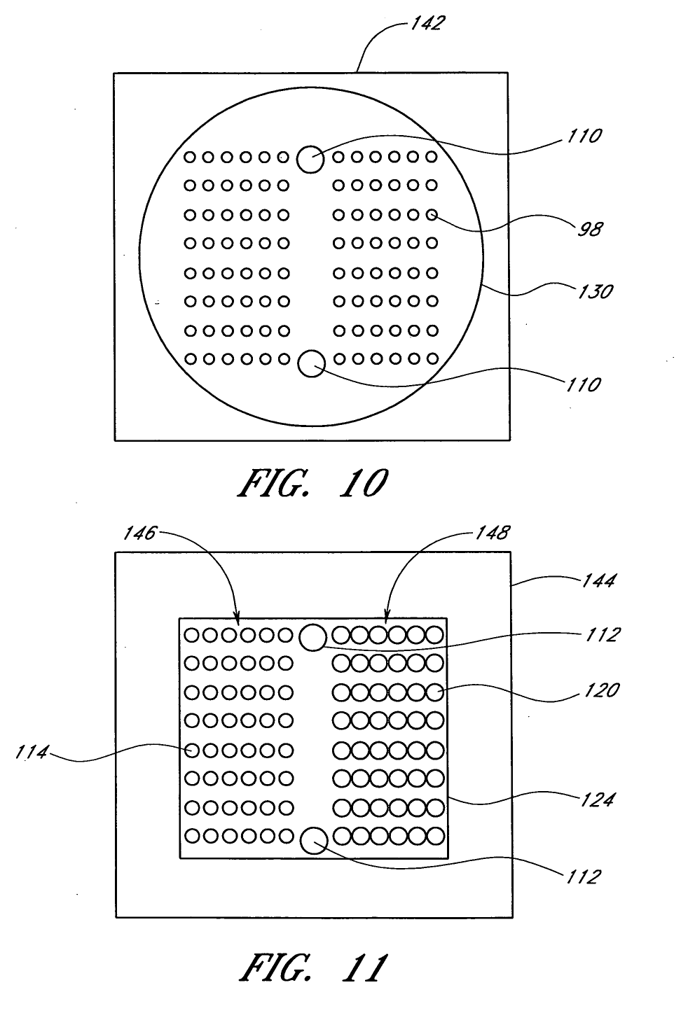

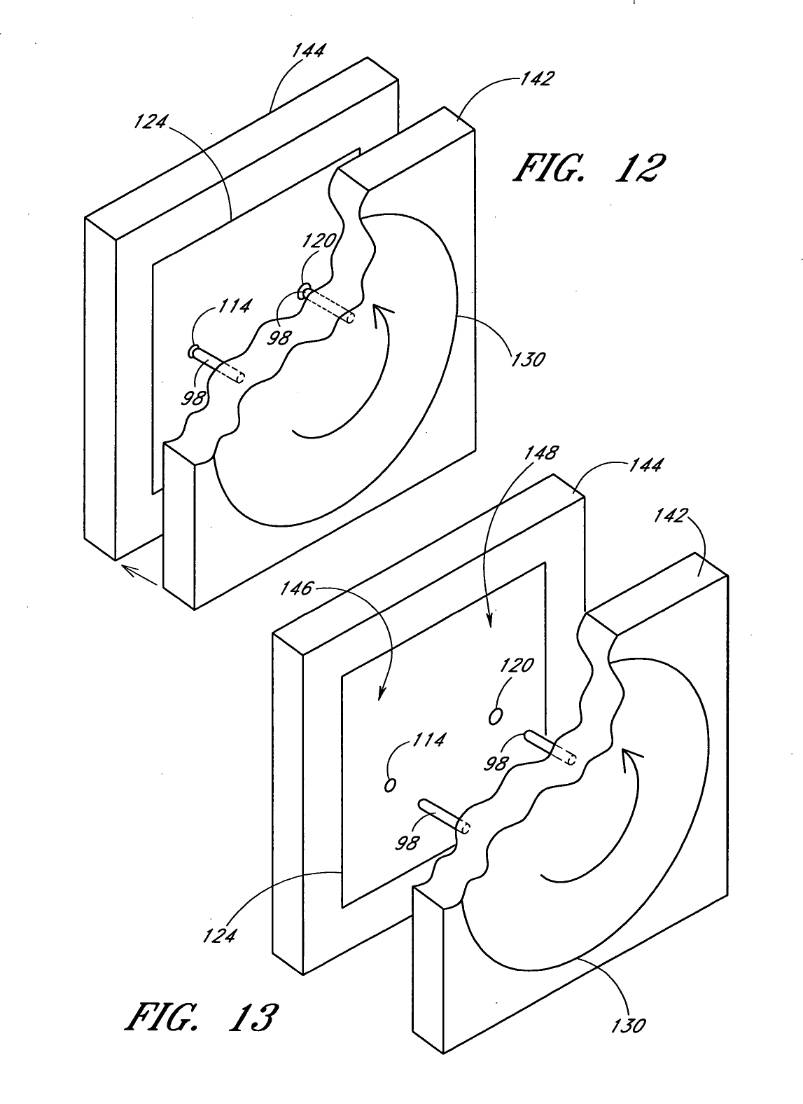

The two mold halves depicted in FIGS. 10 and 11 illustrate an embodiment of a mold of a 48/48 cavity machine as discussed for FIGS. 8 and 9. Referring to FIG. 12 there is shown a perspective view of a mold of the type for an overmolding (inject-over-inject) process in which the mandrels 98 are partially located within the cavities 114 and 120. The arrow shows the movement of the movable mold half 142, on which the mandrels 98 lie, as the mold closes.

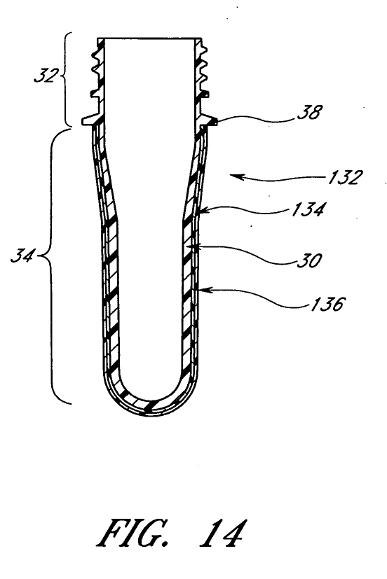

FIG. 13 shows a perspective view of a mold of the type used in an overmolding process, wherein the mandrels 98 are fully withdrawn from the cavities 114 and 120. The arrow indicates that the turntable 130 rotates 180° to move the mandrels 98 from one cavity to the next. On the stationary half 144, the cooling for the preform molding cavity 114 is separate from the cooling for the preform coating cavity 120. Both of these are separate from the cooling for the mandrels 98 in the movable half.

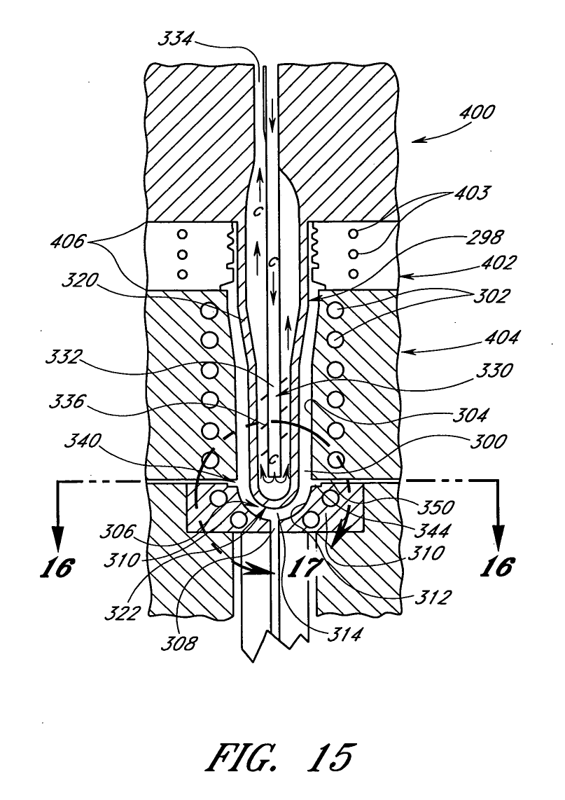

Referring to FIG. 14 there is shown a preferred three-layer preform 132. This embodiment of coated preform is preferably made by placing two coating layers 134 and 136 on a preform 30 such as that shown in FIG. 1.

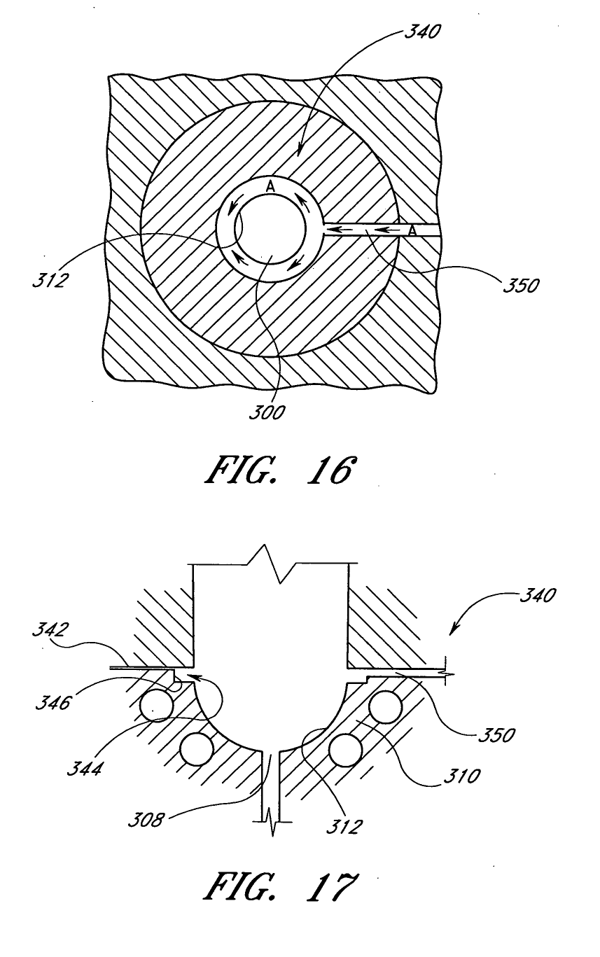

With next reference to FIG. 15, a preferred embodiment of a mold core 298 and associated cavity 300 are shown. Cooling tubes or channels 302 are formed in a spiral fashion just below the surface 304 of the mold cavity 300. A gate area 306 of the cavity 300 is defined near a gate 308 and an insert 310 of a material with especially high heat transfer properties is disposed in the cavity at the gate area 306. Thus, the injected preform's gate area/base end 314 is cooled especially quickly.

The core 298 is hollow and has a wall 320 of generally uniform thickness. A bubbler cooling arrangement 330 is disposed within the hollow core 298 and comprises a core tube 332 located centrally within the core 298 which delivers chilled coolant C directly to a base end 322 of the core 298. Coolant C works its way up the mandrel from the base end 322 and exits through an output line 334. The core tube is held in place by ribs 336 extending between the tube and the mandrel wall 320.

The body mold 404 has several cooling tubes 302 through which a chilled fluid, preferably water, is circulated. The neck finish mold 402 has several tubes 403 in which a fluid circulates. The fluid and circulation of tubes 403 and cooling tubes 302 are separate and independent. The coolant C circulating through the core section 400 is also separate from both tubes 403 and cooling tubes 302. However, a single coolant source may provide the coolant C for both core section 400 and cooling tubes 302 within the body portion 404 of the mold.

The thermal isolation of the body mold 404, neck finish mold 402 and core section 400 is achieved by use of inserts 406 having low thermal conductivity. However, materials having low thermal conductivity should not be used on the molding surfaces which contact the preform. Examples of preferred low thermal conductivity materials include heat-treated tool steel (e.g. P-20, H-13, Stainless etc.), polymeric inserts of filled polyamides, nomex, air gaps and minimum contact shut-off surfaces.

In this independent fluid circuit through tubes 403, the fluid would be warmer than that used in the portions of the mold used to form non-crystalline portions of the preform. Preferred fluids include water, silicones, and oils. In another embodiment, the portions of the mold which forms the crystalline portions of the preform, (corresponding to neck finish mold 402) contains a heating/cooling apparatus placed in the neck, neck finish, and/or neck cylinder portions of the mold so as to maintain the higher temperature (slower cooling) needed to promote crystallinity of the material during cooling. Such a heating or cooling apparatus, but is not limited to, heating coils, heating probes, cooling channels, and electric heaters.

Referring also to FIGS. 16 and 17, an air insertion system 340 is shown formed at a joint 342 between members of the mold cavity 300. A notch 344 is formed circumferentially around the cavity 300. The notch 344 is sufficiently small that substantially no molten plastic will enter during melt injection. An air line 350 connects the notch 344 to a source of air pressure and a valve regulates the supply of air to the notch 344. During melt injection, the valve is closed. When injection is complete, the valve is opened and pressurized air A (FIG. 16) is supplied to the notch 344 in order to defeat a vacuum that may form between an injected preform and the cavity wall 304. Additionally, similar air insertion systems 340 may be utilized in other portions of the mold, such as the thread area, for example but without limitation.

The preferred method and apparatus for making multilayer preforms (e.g., barrier coated preforms) is discussed in more detail below. Because the methods and apparatus are especially preferred for use in forming barrier coated bottles comprising certain preferred materials, the physical characteristics, identification, preparation and enhancement of the preferred materials is discussed prior to the preferred methods and apparatus for working with the materials.

A. Physical Characteristics of Preferred Barrier Materials

Preferred barrier materials preferably exhibit several physical characteristics which allow for the barrier coated bottles and articles according to preferred embodiments to be able to withstand processing and physical stresses in a manner similar or superior to that of uncoated PET articles, in addition to producing articles which are cosmetically appealing and have excellent barrier properties.

Adhesion is the union or sticking together of two surfaces. The actual interfacial adhesion is a phenomenon which occurs at the microscopic level. It is based upon molecular interactions and depends upon chemical bonding, van der Waals forces and other intermolecular attractive forces at the molecular level.

Good adhesion between the barrier layer and the PET layer is especially important when the article is a barrier bottle made by blow-molding a preform. If the materials adhere well, then they will act as one unit when they are subjected to a blow molding process and as they are subjected to stresses when existing in the form of a container. Where the adhesion is poor, delamination results either over time or under physical stress such as squeezing the container or the container jostling during shipment. Delamination is not only unattractive from a commercial standpoint, it may be evidence of a lack of structural integrity of the container. Furthermore, good adhesion means that the layers will stay in close contact when the container is expanded during the molding process and will move as one unit. When the two materials act in such a manner, it is less likely that there will be voids in the coating, thus allowing a thinner coating to be applied. The barrier materials preferably adhere sufficiently to PET such that the barrier layer cannot be easily pulled apart from the PET layer at 22° C.

The glass transition temperature (Tg) is defined as the temperature at which a non-crystallizable polymer undergoes the transformation from a soft rubber state to a hard elastic polymer glass. In a range of temperatures above its Tg, a material will become soft enough to allow it to flow readily when subjected to an external force or pressure, yet not so soft that its viscosity is so low that it acts more like a liquid than a pliable solid. The temperature range above Tg is the preferred temperature range for performing a blow-molding process, as the material is soft enough to flow under the force of the air blown into the preform to fit the mold but not so soft that it breaks up or becomes uneven in texture. Thus, when materials have similar glass transition temperatures, they will have similar preferred blowing temperature ranges, allowing the materials to be processed together without compromising the performance of either material.

In the blow-molding process to produce bottle from a preform, as is known in the art, the preform is heated to a temperature slightly above the Tg of the preform material so that when air is forced into the preform's interior, it will be able to flow to fill the mold in which it is placed. If one does not sufficiently heat the preform and uses a temperature below the Tg, the preform material will be too hard to flow properly, and would likely crack, craze, or not expand to fill the mold. Conversely, if one heats the preform to a temperature well above the Tg, the material would likely become so soft that it would not be able to hold its shape and would process improperly.

If a barrier coating material has a Tg similar to that of PET, it will have a blowing temperature range similar to PET. Thus, if a PET preform is coated with such a barrier material, a blowing temperature can be chosen that allows both materials to be processed within their preferred blowing temperature ranges. If the barrier coating were to have a Tg dissimilar to that of PET, it would be difficult, if not impossible, to choose a blowing temperature suitable for both materials. When the barrier coating materials have a Tg similar to PET, the coated preform behaves during blow molding as if it were made of one material, expanding smoothly and creating a cosmetically appealing container with an even thickness and uniform coating of the barrier material where it is applied.

The glass transition temperature of PET occurs in a window of about 75-85° C., depending upon how the PET has been processed previously. The Tg for preferred barrier materials is preferably 55 to 140° C., more preferably 90 to 110° C.

Another factor which has an impact on the performance of barrier preforms during blow molding is the state of the material. The preferred barrier materials of preferred embodiments are amorphous rather than crystalline. This is because materials in an amorphous state are easier to form into bottles and containers by use of a blow molding process than materials in a crystalline state. PET can exist in both crystalline and amorphous forms. However, in preferred embodiments it is highly preferred that the crystallinity of the PET be minimized and the amorphous state maximized in order to create a semi-crystalline state which, among other things, aids interlayer adhesion and in the blow molding process. A PET article formed from a melt of PET, as in injection molding, can be guided into a semi-crystalline form by cooling the melt at a high rate, fast enough to quench the crystallization process, freezing the PET in a mostly amorphous state. Additionally, use of “high IPA PET” as described earlier herein will allow easier quenching of the crystallization process because it crystallizes at a lower rate than homopolymer PET.

Intrinsic viscosity and melt index are two properties which are related to a polymer's molecular weight. These properties give an indication as to how materials will act under various processing conditions, such as injection molding and blow molding processes.

Barrier materials for use in the articles and methods according to preferred embodiments have an intrinsic viscosity of preferably 0.70-0.90 dl/g, more preferably 0.74-0.87 dl/g, most preferably 0.84-0.85 dl/g and a melt index of preferably 5-30, more preferably 7-12, most preferably 10.

Barrier materials preferably have tensile strength and creep resistance similar to PET. Similarity in these physical properties allows the barrier coating to act as more than simply a gas barrier. A barrier coating having physical properties similar to PET acts as a structural component of the container, allowing the barrier material to displace some of the polyethylene terephthalate in the container without sacrificing container performance. Displacement of PET allows for the resulting barrier-coated containers to have physical performance and characteristics similar to their uncoated counterparts without a substantial change in weight or size. It also allows for any additional cost from adding the barrier material to be defrayed by a reduction in the cost per container attributed to PET.

Similarity in tensile strength between PET and the barrier coating materials helps the container to have structural integrity. This is especially important if some PET is displaced by barrier material. Barrier-coated bottles and containers having features in accordance with preferred embodiments are able to withstand the same physical forces as an uncoated container, allowing, for example, barrier-coated containers to be shipped and handled in the customary manner of handling uncoated PET containers. If the barrier-coating material were to have a tensile strength substantially lower than that of PET, a container having some PET displaced by barrier material would likely not be able to withstand the same forces as an uncoated container.

Similarity in creep resistance between PET and the barrier coating materials helps the container to retain its shape. Creep resistance relates to the ability of a material to resist changing its shape in response to an applied force. For example, a bottle which holds a carbonated liquid needs to be able to resist the pressure of dissolved gas pushing outward and retains its original shape. If the barrier coating material were to have a substantially lower resistance to creep than PET in a container, the resulting container would be more likely to deform over time, reducing the shelf-life of the product.

For applications where optical clarity is of importance, preferred barrier materials have an index of refraction similar to that of PET. When the refractive index of the PET and the barrier coating material are similar, the preforms and, perhaps more importantly, the containers blown therefrom are optically clear and, thus, cosmetically appealing for use as a beverage container where clarity of the bottle is frequently desired. If, however, the two materials have substantially dissimilar refractive indices when they are placed in contact with each other, the resulting combination will have visual distortions and may be cloudy or opaque, depending upon the degree of difference in the refractive indices of the materials.

Polyethylene terephthalate has an index of refraction for visible light within the range of about 1.40 to 1.75, depending upon its physical configuration. When made into preforms, the refractive index is preferably within the range of about 1.55 to 1.75, and more preferably in the range of 1.55-1.65. After the preform is made into a bottle, the wall of the final product, may be characterized as a biaxially-oriented film since it is subject to both hoop and axial stresses in the blow molding operation. Blow molded PET generally exhibits a refractive index within the range of about 1.40 to 1.75, usually about 1.55 to 1.75, depending upon the stretch ratio involved in the blow molding operation. For relatively low stretch ratios of about 6:1, the refractive index will be near the lower end, whereas for high stretch ratios, about 10:1, the refractive index will be near the upper end of the aforementioned range. It will be recognized that the stretch ratios referred to herein are biaxial stretch ratios resulting from and include the product of the hoop stretch ratio and the axial stretch ratio. For example, in a blow molding operation in which the final preform is enlarged by a factor of 2.5 in the axial direction and a factor of 3.5 diametrically, the stretch ratio will be about 8.75 (2.5×3.5).

Using the designation ni to indicate the refractive index for PET and no to indicate the refractive index for the barrier material, the ratio between the values ni and no is preferably 0.8-1.3, more preferably 1.0-1.2, most preferably 1.0-1.1. As will be recognized by those skilled in the art, for the ratio ni/no=1 the distortion due to refractive index will be at a minimum, because the two indices are identical. As the ratio progressively varies from one, however, the distortion increases progressively.

B. Preferred Barrier Coating Materials and Their Preparation

The preferred barrier coating materials for use in the articles and methods described herein include Phenoxy-type Thermoplastic materials, copolyesters of terephthalic acid, isophthalic acid, and at least one diol having good barrier properties as compared to PET (Copolyester Barrier Materials), polyamides, Polyamide Blends, PEN, PEN copolymers, PEN/PET blends, and combinations thereof. Preferably, the Phenoxy-type Thermoplastics used as barrier materials are of the types discussed in U.S. Pat. No. 6,312,641, issued Nov. 6, 2001, and U.S. Pat. No. 6,391,408, issued May 21, 2002, as well as U.S. patent application Ser. No. 09/844,820, filed Apr. 27, 2001, the entireties of which are hereby expressly incorporated by reference herein. In addition, other preferred barrier materials include polyethylene naphthalate (PEN), PEN copolyester, and PET/PEN blends. PEN materials can be purchased from Shell Chemical Company.

C. Preparation of Polyesters

Polyesters and methods for their preparation (including the specific monomers employed in their formation, their proportions, polymerization temperatures, catalysts and other conditions) are well-known in the art and reference is made thereto for the purposes herein. For purposes of illustration and not limitation, reference is particularly made to pages 1-62 of Volume 12 of the Encyclopedia of Polymer Science and Engineering, 1988 revision, John Wiley & Sons.

Typically, polyesters are derived from the reaction of a di- or polycarboxylic acid with a di- or polyhydric alcohol. Suitable di- or polycarboxylic acids include polycarboxylic acids and the esters and anthydrides of such acids, and mixture thereof. Representative carboxylic acids include phthalic, isophthalic, adipic azelaic, terephthalic, oxalic, malonic, succinic, glutaric, sebacic, and the like. Dicarboxylic components are preferred. Terephthalic acid is most commonly employed and preferred in the preparation of polyester films. α,β-Unsaturated di- and polycarboxylic acids (including esters or anthydrides of such acids and mixtures thereof) can be used as partial replacement for the saturated carboxylic components. Representative α,β-unsaturated di- and polycarboxylic acids include maleic, fumaric, aconitic, itaconic, mesaconic, citraconic, monochloromaleic and the like.

Typical di- and polyhydric alcohols used to prepare the polyester are those alcohols having at least two hydroxy groups, although minor amounts of alcohol having more or less hydroxy groups may be used. Dihydroxy alcohols are preferred. Dihydroxy alcohols conventionally employed in the preparation of polyesters include diethylene glycol; dipropylene glycol; ethylene glycol; 1,2-propylene glycol; 1,4-butanediol; 1,4-pentanediol; 1,5-hexanediol, 1,4-cyclohexanedimethanol and the like with 1,2-propylene glycol being preferred. Mixtures of the alcohols can also be employed. The di- or polyhydric alcohol component of the polyester is usually stoichiometric or in slight excess with respect to the acid. The excess of the di- or polyhydric alcohol will seldom exceed about 20 to 25 mole percent and usually is between about 2 and about 10 mole percent.

The polyester is generally prepared by heating a mixture of the di- or polyhydric alcohol and the di- or polycarboxylic component in their proper molar ratios at elevated temperatures, usually between about 100° C. and 250° C. for extended periods of time, generally ranging from 5 to 15 hours. Polymerization inhibitors such as t-butylcatechol may advantageously be used.

PET, the preferred polyester, which is commonly made by condensation of terephthalic acid and ethylene glycol, may be purchased from Dow Chemical Company (Midland, Mich.), and Allied Signal Inc. (Baton Rouge, La.), among many others.

Preferably, the PET used is that in which isophthalic acid (IPA) is added during the manufacture of the PET to form a copolymer. The amount of IPA added is preferably 2-10% by weight, more preferably 3-8% by weight, most preferably 4-5% by weight. The most preferred range is based upon current FDA regulations which currently do not allow for PET materials having an IPA content of more than 5% to be in contact with food or drink. High-IPA PET (PET having more than about 2% IPA by weight) can be made as discussed above, or purchased from a number of different manufacturers, for instance PET with 4.8% IPA may be purchased from SKF (Italy) and 10% IPA PET may be purchased from INCA (Dow Europe).

Additionally, if a barrier material containing polyamide is chosen, it is preferred to use the Polyamide Blends.

D. Other Materials to Enhance Barrier Properties

The materials noted herein, including base materials, such as PET, barrier materials such as Phenoxy-type Thermoplastics, polyamides and Polyamide Blends, and other materials such as recycled PET may be used in combination with other materials which enhance or provide the barrier properties. Generally speaking, one cause for the diffusion of gases through a material is the existence of gaps or holes in the material at the molecular level through which the gas molecules can pass. The presence of intermolecular forces in a material, such as hydrogen bonding, allows for interchain cohesion in the matrix which closes these gaps and discourages diffusion of gases. One may also increase the gas-barrier ability of good barrier materials by adding an additional molecule or substance which takes advantage of such intermolecular forces and acts as a bridge between polymer chains in the matrix, thus helping to close the holes in the matrix and reduce gas diffusion.

Derivatives of the diol resorcinol (m-dihydroxybenzene), when reacted with other monomers in the manufacture of PHAE, PET, Copolyester Barrier Materials, and other barrier materials, will generally result in a material which has better barrier properties than the same material if it does not contain the resorcinol derivative. For example, resorcinol diglycidyl ether can be used in PHAE and hydroxyethyl ether resorcinol can be used in PET and other polyesters and Copolyester Barrier Materials.

One measure of the efficacy of a barrier is the effect that it has upon the shelf life of the material. The shelf life of a carbonated soft drink in a 32 oz PET non-barrier bottle is approximately 12-16 weeks. Shelf life is determined as the time at which less than 85% of the original amount of carbon dioxide is remaining in the bottle. Bottles coated with PHAE using the inject-over-inject method described below have been found to have a shelf life 2 to 3 times greater than that of PET alone. If, however, PHAE with resorcinol diglycidyl ether is used, the shelf life can be increased to 4 to 5 times that of PET alone.

Another way of enhancing the barrier properties of a material is to add a substance which “plugs” the holes in the polymer matrix and thus discourages gases from passing through the matrix. Alternatively, a substance may aid in creating a more tortuous path for gas molecules to take as they permeate a material. One such substance, referred to herein by the term “Nanoparticles” or “nanoparticular material” are tiny particles of materials which enhance the barrier properties of a material by creating a more tortuous path for migrating oxygen or carbon dioxide. One preferred type of nanoparticular material is a microparticular clay-based product available from Southern Clay Products.

Another way to provide or enhance barrier properties is to include an oxygen scavenger. Oxygen scavengers may be blended with a material by physical blending or mixing of the oxygen scavenger with pellets or flakes of a polymer or by compounding the oxygen scavenger with the polymer. Preferred oxygen scavengers include Amosorb 3000 from Amoco. Preferably, the oxygen scavenger is added at a level of 0.5 to 15% by weight, more preferably 1 to 10% by weight, including 5%, 7% and 9%. Other scavengers may be added at volumes which achieve the desired degree of effect, or at levels at or below which they have been approved for use in connection with packaging such as for foods.

E. Preparing Barrier-Coated Articles

Once a suitable barrier coating material is chosen, the coated preform must be made in a manner that promotes adhesion between the two materials. Generally, adherence between the barrier coating materials and PET increases as the surface temperature of the PET increases. Therefore, it is preferable to perform coating on heated preforms, although the preferred barrier materials will adhere to PET at room temperature. Although this discussion is in terms of barrier materials, the same principles noted herein apply to the coating or overmolding of RPET and PET and other such combinations of materials.

There are a number of methods of producing a coated PET preform in accordance with the preferred embodiments. Preferred methods include dip coating, spray coating, flame spraying fluidized bed dipping, and electrostatic powder spraying. Each of the above methods is described in U.S. Pat. No. 6,391,408 entitled BARRIER-COATED POLYESTER, which is hereby incorporated by reference in its entirety.

An especially preferred method of producing a coated PET preform is referred to herein generally as overmolding, and sometimes as inject-over-inject (“IOI”). The name refers to a procedure which uses injection molding to inject one or more layers of barrier material over an existing preform, which preferably was itself made by injection molding. The terms “overinjecting” and “overmolding” are used herein to describe the coating process whereby a layer of material, preferably comprising barrier material, is injected over an existing preform. In an especially preferred embodiment, the overinjecting process is performed while the underlying preform has not yet fully cooled. Overinjecting may be used to place one or more additional layers of materials such as those comprising barrier material, recycled PET, or other materials over a coated or uncoated preform. The IOI process is described in the application noted above as well as copending U.S. Pat. No. 6,352,426 entitled APPARATUS AND METHOD FOR MAKING BARRIER-COATED POLYESTER, which is hereby incorporated by reference in its entirety. This application also incorporates by reference in their entirety abandoned U.S. application Ser. No. 09/844,820, filed on Apr. 27, 2001, and U.S. application Ser. No. 09/949,413, filed on Sep. 5, 2001.

1. Preferred Overmolding (Inject-over-Inject) Processes

The overmolding is preferably carried out by using an injection molding process using equipment similar to that used to form the uncoated preform itself. A preferred mold for overmolding, with an uncoated preform in place is shown in FIG. 7. The mold comprises two halves, a cavity half 92 and a mandrel half 94, and is shown in FIG. 7 in the closed position prior to overinjecting. The cavity half 92 comprises a cavity in which the uncoated preform is placed. The support ring 38 of the preform rests on a ledge 96 and is held in place by the mandrel half 94, which exerts pressure on the support ring 38, thus sealing the neck portion off from the body portion of the preform. The cavity half 92 has a plurality of tubes or channels 104 therein which carry a fluid. Preferably the fluid in the channels circulates in a path in which the fluid passes into an input in the cavity half 92, through the channels 104, out of the cavity half 92 through an output, through a chiller or other cooling device, and then back into the input. The circulating fluid serves to cool the mold, which in turn cools the plastic melt which is injected into the mold to form the coated preform.

The mandrel half 94 of the mold comprises a mandrel 98. The mandrel 98, sometimes called a core, protrudes from the mandrel half 94 of the mold and occupies the central cavity of the preform. In addition to helping to center the preform in the mold, the mandrel 98 cools the interior of the preform. The cooling is done by fluid circulating through channels 106 in the mandrel half 94 of the mold, most importantly through the length of the mandrel 98 itself. The channels 106 of the mandrel half 94 work in a manner similar to the channels 104 in the cavity half 92, in that they create the portion of the path through which the cooling fluid travels which lies in the interior of the mold half.

As the preform sits in the mold cavity, the body portion of the preform is centered within the cavity and is completely surrounded by a void space 100. The preform, thus positioned, acts as an interior die mandrel in the subsequent injection procedure. The melt of the overmolding material, preferably comprising a barrier material, is then introduced into the mold cavity from the injector via gate 102 and flows around the preform, preferably surrounding at least the body portion 34 of the preform. Following overinjection, the overmolded layer will take the approximate size and shape of the void space 100.

To carry out the overmolding procedure, one preferably heats the initial preform which is to be coated preferably to a temperature above its Tg. In the case of PET, that temperature is preferably about 60 to 175° C., more preferably about 80-110° C. If a temperature at or above the minimum temperature of crystallization for PET is used, which is about 120° C., care should be taken when cooling the PET in the preform. The cooling should be sufficient to minimize crystallization of the PET in the preform so that the PET is in the preferred semi-crystalline state. Advantageously, the neck portion of the preform is not in contact with the melt of overmolding material, and thus retains its crystalline structure. Alternatively, the initial preform used may be one which has been very recently injection molded and not fully cooled, as to be at an elevated temperature as is preferred for the overmolding process.

The coating material is heated to form a melt of a viscosity compatible with use in an injection molding apparatus. The temperature for this, the inject temperature, will differ among materials, as melting ranges in polymers and viscosities of melts may vary due to the history, chemical character, molecular weight, degree of branching and other characteristics of a material. For the preferred barrier materials disclosed above, the inject temperature is preferably in the range of about 160-325° C., more preferably 200 to 275° C. For example, for the Copolyester Barrier Material B-010, the preferred temperature is around 210° C., whereas for the PHAE XU-19040.00L, BLOX 0005 or BLOX 0003 the preferred temperature is in the range of 160-260° C., and is more preferably about 175-240° C. Most preferably, the PHAE inject temperature is about 175-200° C. If recycled PET is used, the inject temperature is preferably 250-320° C. The coating material is then injected into the mold in a volume sufficient to fill the void space 100. If the coating material comprises barrier material, the coating layer is a barrier layer.

The coated preform is preferably cooled at least to the point where it can be displaced from the mold or handled without being damaged, and removed from the mold where further cooling may take place. If PET is used, and the preform has been heated to a temperature near or above the temperature of crystallization for PET, the cooling should be fairly rapid and sufficient to ensure that the PET is primarily in the semi-crystalline state when the preform is fully cooled. As a result of this process, a strong and effective bonding takes place between the initial preform and the subsequently applied coating material.

Overmolding can be also used to create coated preforms with three or more layers. In FIG. 14, there is shown a three-layer embodiment of a preform 132 in accordance with one preferred embodiment. The preform shown therein has two coating layers, a middle layer 134 and an outer layer 136. The relative thickness of the layers shown in FIG. 16 may be varied to suit a particular combination of layer materials or to allow for the making of different sized bottles. As will be understood by one skilled in the art, a procedure analogous to that disclosed above would be followed, except that the initial preform would be one which had already been coated, as by one of the methods for making coated preforms described herein, including overmolding.

a. A Preferred Method and Apparatus for Overmolding

A preferred apparatus for performing the overmolding process is based upon the use of a 330-330-200 machine by Engel (Austria). The preferred mold portion the machine is shown schematically in FIGS. 8-13 and comprises a movable half 142 and a stationary half 144. In one preferred embodiment, both halves are preferably made from hard metal. The stationary half 144 comprises at least two mold sections 146, 148, wherein each mold section comprises N (N>0) identical mold cavities 114, 120, an input and output for cooling fluid, channels allowing for circulation of cooling fluid within the mold section, injection apparatus, and hot runners channeling the molten material from the injection apparatus to the gate of each mold cavity. Because each mold section forms a distinct preform layer, and each preform layer is preferably made of a different material, each mold section is separately controlled to accommodate the potentially different conditions required for each material and layer. The injector associated with a particular mold section injects a molten material, at a temperature suitable for that particular material, through that mold section's hot runners and gates and into the mold cavities. The mold section's own input and output for cooling fluid allow for changing the temperature of the mold section to accommodate the characteristics of the particular material injected into a mold section. Consequently, each mold section may have a different injection temperature, mold temperature, pressure, injection volume, cooling fluid temperature, etc. to accommodate the material and operational requirements of a particular preform layer.

The movable half 142 of the mold comprises a turntable 130 and a plurality of cores or mandrels 98. The alignment pins guide the movable half 142 to slidably move in a preferably horizontal direction towards or away from the stationary half 144. The turntable 130 may rotate in either a clockwise or counterclockwise direction, and is mounted onto the movable half 142. The plurality of mandrels 98 are affixed onto the turntable 130. These mandrels 98 serve as the mold form for the interior of the preform, as well as serving as a carrier and cooling device for the preform during the molding operation. The cooling system in the mandrels is separate from the cooling system in the mold sections.

The mold temperature or cooling for the mold is controlled by circulating fluid. There is separate cooling fluid circulation for the movable half 142 and for the overmolding section 148 of the stationary half 144. Additionally, the initial preform mold section 146 of the stationary half 144 comprises two separate cooling fluid circulation systems; one for the non-crystalline regions and one for the crystalline regions. Each cooling fluid circulation set up works in a similar manner. The fluid enters the mold, flows through a network of channels or tubes inside as discussed above for FIG. 7, and then exits through an output. From the output, the fluid travels through a pump, which keeps the fluid flowing, and a chilling system to keep the fluid within the desired temperature range, before going back into the mold.

In a preferred embodiment, the mandrels/cores and cavities are constructed of a high heat transfer material, such a beryllium, which is coated with a hard metal, such as tin or chrome. The hard coating keeps the beryllium from direct contact with the preform, as well as acting as a release for ejection and providing a hard surface for long life. The high heat transfer material allows for more efficient cooling, and thus assists in achieving lower cycle times. The high heat transfer material may be disposed over the entire area of each mandrel and/or cavity, or it may be only on portions thereof. Preferably, at least the tips of the mandrels comprise high heat transfer material. Another, even more preferred high heat transfer material is AMPCOLOY, which is commercially available from Uudenholm, Inc.

The number of mandrels is equal to the total number of cavities, and the arrangement of the mandrels 98 on the movable half 142 mirrors the arrangement of the cavities 114, 120 on the stationary half 144. To close the mold, the movable half 142 moves towards the stationary half 144, mating the mandrels 98 with the cavities 114, 120. To open the mold, the movable half 142 moves away from the stationary half 144 such that the mandrels 98 are well clear of the block on the stationary half 144. After the mandrels 98 are fully withdrawn 98 from the mold sections 146, 148, the turntable 130 of the movable half 142 rotates the mandrels 98 into alignment with a different mold section. Thus, the movable half rotates 360°/(number of mold sections in the stationary half) degrees after each withdrawal of the mandrels from the stationary half. When the machine is in operation, during the withdrawal and rotation steps, there will be preforms present on some or all of the mandrels.

The size of the cavities in a given mold section 146, 148 will be identical; however the size of the cavities will differ among the mold sections. The cavities in which the uncoated preforms are first molded, the preform molding cavities 114, are smallest in size. The size of the cavities 120 in the mold section 148 in which the first coating step is performed are larger than the preform molding cavities 114, in order to accommodate the uncoated preform and still provide space for the coating material to be injected to form the overmolded coating. The cavities in each subsequent mold section wherein additional overmolding steps are performed will be increasingly larger in size to accommodate the preform as it gets larger with each coating step.

After a set of preforms has been molded and overmolded to completion, a series of ejectors eject the finished preforms off of the mandrels 98. The ejectors for the mandrels operate independently, or at least there is a single ejector for a set of mandrels equal in number and configuration to a single mold section, so that only the completed preforms are ejected. Uncoated or incompletely-coated preforms remain on the mandrels so that they may continue in the cycle to the next mold section. The ejection may cause the preforms to completely separate from the mandrels and fall into a bin or onto a conveyor. Alternatively, the preforms may remain on the mandrels after ejection, after which a robotic arm or other such apparatus grasps a preform or group of preforms for removal to a bin, conveyor, or other desired location.

FIGS. 8 and 9 illustrate a schematic for an embodiment of the apparatus described above. FIG. 9 is the stationary half 144 of the mold. In this embodiment, the block 124 has two mold sections, one section 146 comprising a set of three preform molding cavities 114 and the other section 148 comprising a set of three preform coating cavities 120. Each of the preform coating cavities 120 is preferably like that shown in FIG. 7, discussed above. Each of the preform molding cavities 114 is preferably similar to that shown in FIG. 15, in that the material is injected into a space defined by the mandrel 98 (albeit without a preform already thereon) and the wall of the mold which is cooled by fluid circulating through channels inside the mold block. Consequently, one full production cycle of this apparatus will yield three two-layer preforms. If more than three preforms per cycle is desired, the stationary half can be reconfigured to accommodate more cavities in each of the mold sections. An example of this is seen in FIG. 11, wherein there is shown a stationary half of a mold comprising two mold sections, one 146 comprising forty-eight preform molding cavities 114 and the other 148 comprising forty-eight preform coating cavities 120. If a three or more layer preform is desired, the stationary half 144 can be reconfigured to accommodate additional mold sections, one for each preform layer

FIG. 8 illustrates the movable half 142 of the mold. The movable half comprises six identical mandrels 98 mounted on the turntable 130. Each mandrel 98 corresponds to a cavity on the stationary half 144 of the mold. The movable half also comprises alignment pegs 110, which correspond to the receptacles 112 on the stationary half 144. When the movable half 142 of the mold moves to close the mold, the alignment pegs 110 are mated with their corresponding receptacles 112 such that the molding cavities 114 and the coating cavities 120 align with the mandrels 98. After alignment and closure, half of the mandrels 98 are centered within preform molding cavities 114 and the other half of the mandrels 98 are centered within preform coating cavities 120.

The configuration of the cavities, mandrels, and alignment pegs and receptacles must all have sufficient symmetry such that after the mold is separated and rotated the proper number of degrees, all of the mandrels line up with cavities and all alignment pegs line up with receptacles. Moreover, each mandrel must be in a cavity in a different mold section than it was in prior to rotation in order to achieve the orderly process of molding and overmolding in an identical fashion for each preform made in the machine.

Two views of the two mold halves together are shown in FIGS. 12 and 13. In FIG. 12, the movable half 142 is moving towards the stationary half 144, as indicated by the arrow. Two mandrels 98, mounted on the turntable 130, are beginning to enter cavities, one enters a molding cavity 114 and the other is entering a coating cavity 120 mounted in the block 124. In FIG. 13, the mandrels 98 are fully withdrawn from the cavities on the stationary side. The preform molding cavity 114 has two cooling circulation systems which are separate from the cooling circulation for the preform coating cavity 120, which comprises the other mold section 148. The two mandrels 98 are cooled by a single system that links all the mandrels together. The arrow in FIG. 13 shows the rotation of the turntable 130. The turntable 130 could also rotate clockwise. Not shown are coated and uncoated preforms which would be on the mandrels if the machine were in operation. The alignment pegs and receptacles have also been left out for the sake of clarity.

The operation of the overmolding apparatus will be discussed in terms of the preferred two mold section apparatus for making a two-layer preform. The mold is closed by moving the movable half 142 towards the stationary half 144 until they are in contact. A first injection apparatus injects a melt of first material into the first mold section 146, through the hot runners and into the preform molding cavities 114 via their respective gates to form the uncoated preforms each of which become the inner layer of a coated preform. The first material fills the void between the preform molding cavities 114 and the mandrels 98. Simultaneously, a second injection apparatus injects a melt of second material into the second mold section 148 of the stationary half 144, through the hot runners and into each preform coating cavity 120 via their respective gates, such that the second material fills the void (100 in FIG. 9) between the wall of the coating cavity 120 and the uncoated preform mounted on the mandrel 98 therein.

During this entire process, cooling fluid is circulating through the four separate areas, corresponding to the non-crystalline regions of mold section 146 of the preform molding cavities 114, the crystalline regions of mold section 146 of the preform molding cavities 114, mold section 148 of the preform coating cavities 120, and the movable half 142 of the mold, respectively. Thus, the melts and preforms are being cooled in the center by the circulation in the movable half that goes through the interior of the mandrels, as well as on the outside by the circulation in each of the cavities.

The movable half 142 then slides back to separate the two mold halves and open the mold until all of the mandrels 98 having preforms thereon are completely withdrawn from the preform molding cavities 114 and preform coating cavities 120. The ejectors eject the coated, finished preforms off of the mandrels 98 which were just removed from the preform coating cavities. As discussed above, the ejection may cause the preforms to completely separate from the mandrels and fall into a bin or onto a conveyor, or if the preforms remain on the mandrels after ejection, a robotic arm or other apparatus may grasp a preform or group of preforms for removal to a bin, conveyor, or other desired location. The turntable 130 then rotates 180° so that each mandrel 98 having an uncoated preform thereon is positioned over a preform coating cavity 120, and each mandrel from which a coated preform was just ejected is positioned over a preform molding cavity 114. Rotation of the turntable 130 may occur as quickly as 0.5-0.9 seconds. Using the alignment pegs 110, the mold halves again align and close, and the first injector injects the first material into the preform molding cavity 114 while the second injector injects the barrier material into the preform coating cavity 120.

A production cycle of closing the mold, injecting the melts, opening the mold, ejecting finished barrier preforms, rotating the turntable, and closing the mold is repeated, so that preforms are continuously being molded and overmolded.

When the apparatus first begins running, during the initial cycle, no preforms are yet in the preform coating cavities 120. Therefore, the operator should either prevent the second injector from injecting the second material into the second mold section during the first injection, or allow the second material to be injected and eject and then discard the resulting single layer preform comprised solely of the second material. After this start-up step, the operator may either manually control the operations or program the desired parameters such that the process is automatically controlled.

Two layer preforms may be made using the first preferred overmolding apparatus described above. In one preferred embodiment, the two layer preform comprises an inner layer comprising polyester and an outer layer comprising barrier material. In especially preferred embodiments, the inner layer comprises virgin PET. The description hereunder is directed toward the especially preferred embodiments of two layer preforms comprising an inner layer of virgin PET, in which the neck portion is generally crystalline and the body portion is generally non-crystalline. The description is directed toward describing the formation of a single set of coated preforms 60 of the type seen in FIG. 4, that is, following a set of preforms through the process of molding, overmolding and ejection, rather than describing the operation of the apparatus as a whole. The process described is directed toward preforms having a total thickness in the wall portion 66 of about 3 mm, comprising about 2 mm of virgin PET and about 1 mm of barrier material. The thickness of the two layers will vary in other portions of the preform 60, as shown in FIG. 4.

It will be apparent to one skilled in the art that some of the parameters detailed below will differ if other embodiments of preforms are used. For example, the amount of time which the mold stays closed will vary depending upon the wall thickness of the preforms. However, given the disclosure below for this preferred embodiment and the remainder of the disclosure herein, one skilled in the art would be able to determine appropriate parameters for other preform embodiments.

The apparatus described above is set up so that the injector supplying the mold section 146 containing the preform molding cavities 114 is fed with virgin PET and that the injector supplying the mold section 148 containing the preform coating cavities 120 is fed with a barrier material.

The movable half 142 of the mold is moved so that the mold is closed. A melt of virgin PET is injected through the back of the block 124 and into each preform molding cavity 114 to form an uncoated preform 30 which becomes the inner layer of the coated preform. The injection temperature of the PET melt is preferably 250 to 320° C., more preferably 255 to 280° C. The mold is kept closed for preferably 3 to 10 seconds, more preferably 4 to 6 seconds while the PET melt stream is injected and then cooled by the coolant circulating in the mold.

In the first step, the PET substrate is injection molded by injecting molten PET into the cavities formed by the molds and cores in the mold stack. When the cavity is filled, the resin in the body portion will come into contact with cooling surfaces and the resin in the neck finish will come into contact with the heated thread mold. As the PET in the neck finish cools, it will begin to crystallize as a result of this contact with the relatively hot mold. Once in contact, the crystallization will start and continue at a rate determined by time and temperature. When the neck finish portion of the molds are kept above the minimum temperature of crystallization of the PET used, crystallization will begin on contact. Higher temperatures will increase the rate of crystallization and decrease the time required to reach the optimum level of crystallization while maintaining post mold dimensional stability of the neck finish of the preform. At the same time the resin in the neck finish portion is cooling into a crystallized state, the resin in the body portion or lower body portion of the preform will be in contact with the chilled portions of the mold and thus cooled into an amorphous or semi-crystalline state.

The movable half 142 of the mold is then moved so that the two halves of the mold are separated at or past the point where the newly molded preforms, which remain on the mandrels 98, are clear of the stationary side 144 of the mold. When the mandrels 98 are clear of the stationary side 144 of the mold, the turntable 130 then rotates 180° so that each mandrel 98 having a molded preform thereon is positioned over a preform coating cavity 120. Thus positioned, each of the other mandrels 98 which do not have molded preforms thereon, are each positioned over a preform molding cavity 114. The mold is again closed. Preferably the time between removal from the preform molding cavity 114 to insertion into the preform coating cavity 120 is 1 to 10 seconds, and more preferably 1 to 3 seconds.

When the molded preforms are first placed into preform coating cavities 120, the exterior surfaces of the body portions of the preforms are not in contact with a mold surface. Thus, the exterior skin of the body portion is still softened and hot as described above because the contact cooling is only from the mandrel inside. The high temperature of the exterior surface of the uncoated preform (which forms the inner layer of the coated preform) aids in promoting adhesion between the PET and barrier layers in the finished barrier coated preform. It is postulated that the surfaces of the materials are more reactive when hot, and thus chemical interactions between the barrier material and the virgin PET will be enhanced by the high temperatures. Barrier material will coat and adhere to a preform with a cold surface, and thus the operation may be performed using a cold initial uncoated preform, but the adhesion is markedly better when the overmolding process is done at an elevated temperature, as occurs immediately following the molding of the uncoated preform. As discussed earlier, the neck portion of the preform has desirably crystallized from the separated, thermally isolated cooling fluid systems in the preform molding cavity. Since the coating operation does not place barrier material on the neck portion, its crystalline structure is substantially undisturbed.

A second injection operation then follows in which a melt of a barrier material is injected into each preform coating cavity 120 to coat the preforms. The temperature of the melt of barrier material is preferably 160 to 325° C. The exact temperature range for any individual barrier material is dependent upon the specific characteristics of that barrier material, but it is well within the abilities of one skilled in the art to determine a suitable range by routine experimentation given the disclosure herein. For example, if BLOX 0005 or BLOX 0003 is used, the temperature of the melt (inject temperature) is preferably 160 to 260° C., more preferably 200 to 240° C., and most preferably 175 to 200° C. If the Copolyester Barrier Material B-010 is used, the injection temperature is preferably 160 to 260° C., more preferably 190 to 250° C. During the same time that this set of preforms are being overmolded with barrier material in the preform coating cavities 120, another set of uncoated preforms is being molded in the preform molding cavities 114 as described above.

The two halves of the mold are again separated preferably 3 to 10 seconds, more preferably 4 to 6 seconds following the initiation of the injection step. The preforms which have just been barrier coated in the preform coating cavities 120, are ejected from the mandrels 98. The uncoated preforms which were just molded in preform molding cavities 114 remain on their mandrels 98. The turntable 130 is then rotated 180° so that each mandrel having an uncoated preform thereon is positioned over a coating cavity 120 and each mandrel 98 from which a coated preform was just removed is positioned over a molding cavity 114.

The cycle of closing the mold, injecting the materials, opening the mold, ejecting finished barrier preforms, rotating the turntable, and closing the mold is repeated, so that preforms are continuously being molded and overmolded. Those of skill in the art will appreciate that dry cycle time of the apparatus may increase the overall production cycle time for molding a complete preform.

The process using modified molds and chilled cores will produce a unique combination of amorphous/crystalline properties. As the core is chilled and the thread mold is heated, the thermal transfer properties of the PET act as a barrier to heat exchange. The heated thread molds crystallize the PET at the surface of the thread finish, and the PET material transitions into an amorphous form near the core as the temperature of the PET reduces closer to the core. This variation of the material from the inner (core) portion to the outer (thread) portion is also referred to herein as the crystallinity gradient.

The core temperature and the rate of crystallization of the resin play a part in determining the depth of crystallized resin. In addition, the amorphous inner surface of the neck finish stabilizes the post mold dimensions allowing closer molding tolerances than other crystallizing processes. On the other side, the crystallized outer surface supports the amorphous structure during high temperature applications, such as during hot filling of the container. Physical properties are also enhanced (e.g. brittleness, impact etc.) as a result of this unique crystalline/amorphous structure.

The optimum temperature for crystallization may vary depending upon factors including, but not limited to, resin grade, resin crystallization temperature, intrinsic viscosity, wall thickness, exposure time, mold temperature. Preferred resins include PET homopolymer and copolymers (including but not limited to high-IPA PET, Copolyester Barrier Materials, and copolymers of PET and polyamides) and PEN. Such resins preferably have low intrinsic viscosities and moderate melt temperatures, preferably IVs of about 74 is 86, and melt temperatures of about 220-300° C. The preferred mold temperature range for PET is from about 240-280° C., with the maximum crystallization rate occurring at about 180° C., depending upon the above factors, the preferred exposure time range is from about 20 to 60 seconds overall, which includes both injection steps in inject-over-inject embodiments, and the preferred injection cavity pressure range is about 5000 to 22000 PSI. Thicker finish wall thickness will require more time to achieve a particular degree of crystallinity as compared to that needed for a thinner wall thickness. Increases in exposure time (time in mold) will increase the depth of crystallinity and the overall percentage of crystallinity in the area, and changes in the mold temperature in the region for which crystallinity is desired will affect the crystallinity rate and dimensional stability.

One of the many advantages of using the process disclosed herein is that the cycle times for the process are similar to those for the standard process to produce uncoated preforms; that is the molding and coating of preforms by this process is done in a period of time similar to that required to make uncoated PET preforms of similar size by standard methods currently used in preform production. Therefore, one can make barrier coated PET preforms instead of uncoated PET preforms without a significant change in production output and capacity.

If a PET melt cools slowly, the PET will take on a crystalline form. Because crystalline polymers do not blow mold as well as amorphous polymers, a preform comprised of a body portion of crystalline PET would not be expected to perform as well in forming containers as one having a body portion formed of PET having a generally non-crystalline form. If, however, the body portion is cooled at a rate faster than the crystal formation rate, as is described herein, crystallization of the PET will be minimized and the PET will take on an amorphous or semi-crystalline form. Thus, sufficient cooling of the PET in the body portion of the preform is crucial to forming preforms which will perform as needed when processed.

The rate at which a layer of PET cools in a mold such as described herein is proportional to the thickness of the layer of PET, as well as the temperature of the cooling surfaces with which it is in contact. If the mold temperature factor is held constant, a thick layer of PET cools more slowly than a thin layer. This is because it takes a longer period of time for heat to transfer from the inner portion of a thick PET layer to the outer surface of the PET which is in contact with the cooling surfaces of the mold than it would for a thinner layer of PET because of the greater distance the heat must travel in the thicker layer. Thus, a preform having a thicker layer of PET needs to be in contact with the cooling surfaces of the mold for a longer time than does a preform having a thinner layer of PET. In other words, with all things being equal, it takes longer to mold a preform having a thick wall of PET than it takes to mold a preform having a thin wall of PET.

The uncoated preforms, including those made by the first injection in the above-described apparatus, are preferably thinner than a conventional PET preform for a given container size. This is because in making the barrier coated preforms, a quantity of the PET which would be in a conventional PET preform can be displaced by a similar quantity of one of the preferred barrier materials. This can be done because the preferred barrier materials have physical properties similar to PET, as described above. Thus, when the barrier materials displace an approximately equal quantity of PET in the walls of a preform or container, there will not be a significant difference in the physical performance of the container. Because the preferred uncoated preforms which form the inner layer of the barrier coated preforms are thin-walled, they can be removed from the mold sooner than their thicker-walled conventional counterparts. For example, the uncoated preform can be removed from the mold preferably after about 4-6 seconds without the body portion crystallizing, as compared to about 12-24 seconds for a conventional PET preform having a total wall thickness of about 3 mm. All in all, the time to make a barrier coated preform is equal to or slightly greater (up to about 30%) than the time required to make a monolayer PET preform of this same total thickness.

Additionally, because the preferred barrier materials are amorphous, they will not require the same type of treatment as the PET. Thus, the cycle time for a molding-overmolding process as described above is generally dictated by the cooling time required by the PET. In the above-described method, barrier coated preforms can be made in about the same time it takes to produce an uncoated conventional preform.

The advantage gained by a thinner preform can be taken a step farther if a preform made in the process is of the type in FIG. 4. In this embodiment of a coated preform, the PET wall thickness at 70 in the center of the area of the end cap 42 is reduced to preferably about ⅓ of the total wall thickness. Moving from the center of the end cap out to the end of the radius of the end cap, the thickness gradually increases to preferably about ⅔ of the total wall thickness, as at reference number 68 in the wall portion 66. The wall thickness may remain constant or it may, as depicted in FIG. 4, transition to a lower thickness prior to the support ring 38. The thickness of the various portions of the preform may be varied, but in all cases, the PET and barrier layer wall thicknesses must remain above critical melt flow thickness for any given preform design.

Using preforms 60 of the design in FIG. 4 allows for even faster cycle times than that used to produce preforms 50 of the type in FIG. 3. As mentioned above, one of the biggest barriers to short cycle time is the length of time that the PET needs to be cooled in the mold following injection. If the body portion of a preform comprising PET has not sufficiently cooled before it is ejected from the mandrel, it will become substantially crystalline and potentially cause difficulties during blow molding. Furthermore, if the PET layer has not cooled enough before the overmolding process takes place, the force of the barrier material entering the mold will wash away some of the PET near the gate area. The preform design in FIG. 4 takes care of both problems by making the PET layer thinnest in the center of the end cap region 42, which is where the gate is in the mold. The thin gate section allows the gate area to cool more rapidly, so that the uncoated PET layer may be removed from the mold in a relatively short period of time while still avoiding crystallization of the gate area and washing of the PET during the second injection or overmolding phase.

The physical characteristics of the preferred barrier materials help to make this type of preform design workable. Because of the similarity in physical properties, containers having wall portions which are primarily barrier material can be made without sacrificing the performance of the container. If the barrier material used were not similar to PET, a container having a variable wall composition as in FIG. 4 would likely have weak spots or other defects that could affect container performance.

b. Improving Mold Performance

As discussed above, the mold halves have an extensive cooling system comprising circulating coolant throughout the mold in order to conduct heat away and thus enhance the mold's heat absorption properties. With next reference to FIG. 15, which is a cross-section of a mold mandrel or core 298 and cavity 300 having features in accordance with preferred embodiments, the mold cooling system can be optimized for the mold cavities by arranging cooling tubes 302 in a spiral fashion around the mold cavity 300 and just below the surface 304. The rapid cooling enabled by such a cooling system helps avoid crystallization of the PET layer in the body portion of the preform during cooling. Also, the rapid cooling decreases the production cycle time by allowing injected preforms to be removed from the mold cavities quickly so that the mold cavity 300 may be promptly reused.

As discussed above, the gate area 306 of the mold cavity 300 is especially pivotal in determining cycle time. The void space near the gate 308, which will make up the molded preform's base end 304, receives the last portion of the melt stream to be injected into the mold cavity 300. Thus, this portion is the last to begin cooling. If the PET layer has not sufficiently cooled before the overmolding process takes place, the force of the barrier material melt entering the mold may wash away some of the PET near the gate area 306. To speed cooling in the gate area of the mold cavity in order to decrease cycle time, inserts 310 of an especially high heat transfer material, including, but not limited to, a beryllium-free copper alloy (sold under the trade name AMPCOLOY), can be disposed in the mold in the gate area 308. These AMPCOLOY inserts 310 will withdraw heat at an especially fast rate. To enhance and protect the AMPCOLOY inserts 310, a thin layer of titanium nitride or hard chrome may be deposited on the surface 312 of the AMPCOLOY to form a hard surface. Such a deposited surface would be preferably between only 0.001 to 0.01 inches thick and would most preferably be about 0.002 inches thick.

As discussed above, the core 298 is especially important in the cooling process because it directly cools the inner PET layer. To enhance the cooling effect of the core 298 on the inner surface of the preform and especially to enhance the cooling effect of the core 298 at the preform's gate area/base end 314, the core 298 is preferably substantially hollow, having a relatively thin uniform wall 320, as shown in FIG. 16. Preferably, this uniform thickness is between 0.1 inch and 0.3 inches and is most preferably about 0.2 inches. It is particularly important that the wall 320 at the base end 322 of the core 298 is no thicker than the rest of the mandrel wall 314 because the thin wall aids in rapidly communicating heat away from the molten gate area 314 of the injected preform.

To further enhance the mandrel's cooling capability, cooling water may be supplied in a bubbler arrangement 330. A core tube 332 is disposed centrally in the core 298 and delivers chilled coolant C to the base end 322 thereof. Since the base end 322 is the first point of the core 298 contacted by this coolant C, the coolant is coldest and most effective at this location. Thus, the gate area 314 of the injected preform is cooled at a faster rate than the rest of the preform. Coolant injected into the mandrel at the base end 322 proceeds along the length of the core 298 and exits through an output line 334. A plurality of ribs 336 are arranged in a spiral pattern around the core tube 332 to direct coolant C along the mandrel wall.

In other embodiments where greater crystallinity and less crystalline gradient is desired, molds which are modified as described above are paired with cores modified as follows. In the modified cores, the fluid circulation in the cores is modified such that, for the portions to form the crystalline preform parts, the fluid circulation is independent and at a relatively higher temperature, or the flow of chilled fluid is restricted or altered in these regions such that the temperature of the surface of the core in the portion which forms the crystalline portion of the preform is higher than that in the body regions. Alternatively, the relevant portions of the core may be heated other means as described above. Use of cores having these characteristics allows for a greater degree of crystallization towards and/or at the inner surface of the preform in the neck, neck finish and/or neck cylinder area and a lesser crystalline gradient between the inner surface and the outer surface in these areas.

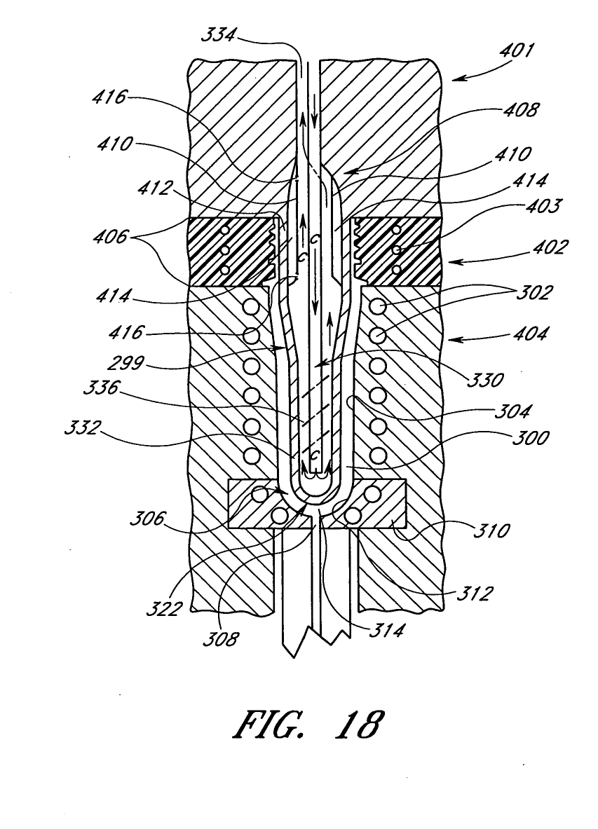

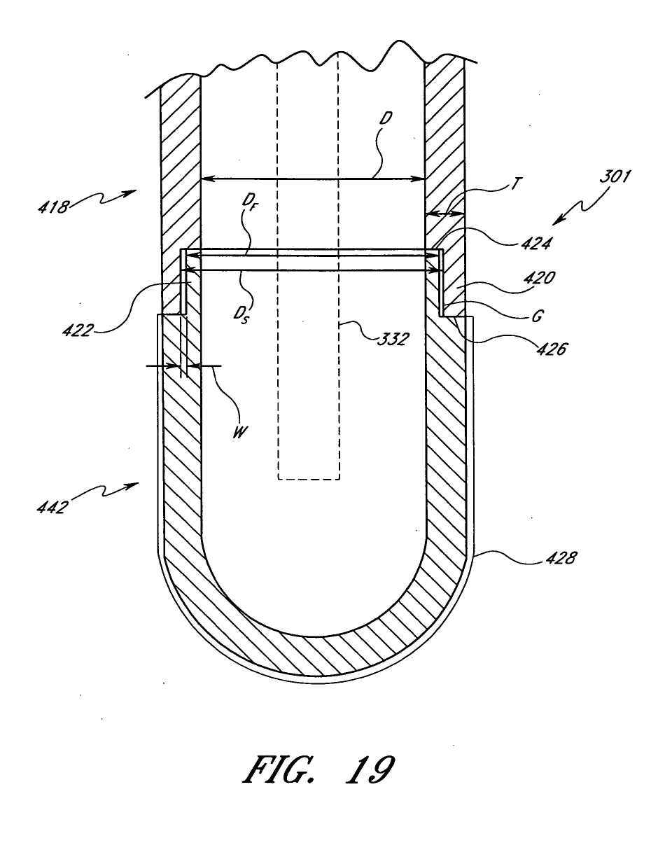

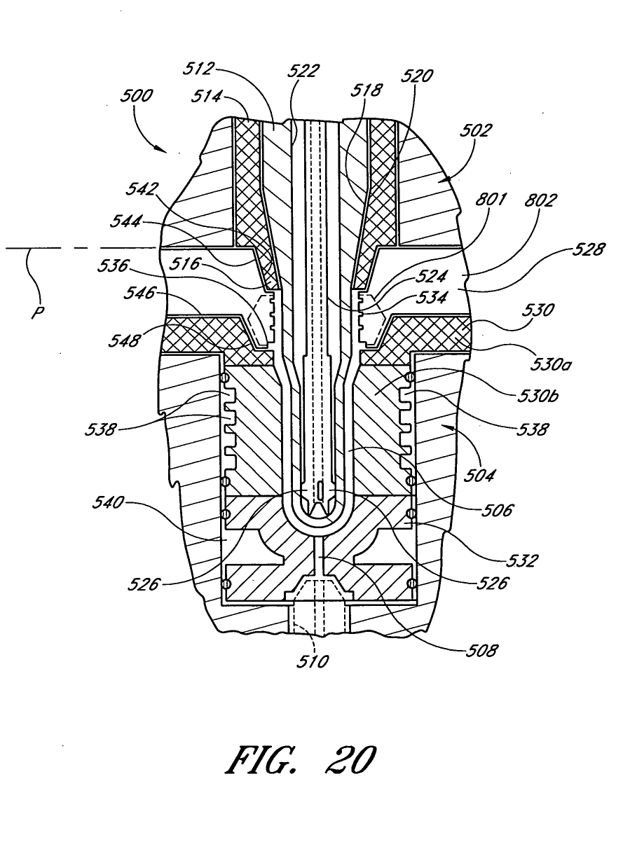

FIG. 18 is a schematic representation of one such modified core 299, configured to achieve greater crystallinity of the neck portion of an injected preform. The mold of FIG. 18 is similar in construction to the mold described above with reference to FIG. 15 and includes a core section 401, the body mold 400, and the neck finish portion 402.

The core 299 of FIG. 18 includes a double wall portion 408 generally adjacent to the neck finish portion 402 of the mold. An inner wall 410 substantially inhibits circulating fluid C from coming into contact with the outer wall 416 of the core 299 in the region proximate the neck finish portion 402 of the mold. In addition, an insulating space 414 is defined between the inner wall and outer wall 412. Accordingly, the insulating space 414 reduces the cooling effect of the circulating fluid C on the neck portion of a preform within the mold cavity 300 thereby increasing the crystallinity of the resulting preform, and reducing the crystallinity gradient between the outer surface and the inner surface of the resulting preform.

The inner wall 410 of the modified core 299 may optionally include one or more openings 416. These openings 416 permit circulating fluid C to enter the insulating space 414. Preferably, the size of the openings 416 are configured such that a limited amount of circulating fluid C enters the insulating space 414. Such a construction provides a greater cooling effect on the neck portion of the resulting preform than when no fluid is permitted within the insulating space 414, but less cooling than unrestricted contact of the circulating fluid C with the outer wall 412 of the core 299. Advantageously, adjustment of the size and placement of the openings 416 allows adjustment of the cooling on the neck portion of the injected preform, thereby allowing adjustment of the crystallinity and crystallinity gradient in the neck portion.

As used herein, the term “high heat transfer material” is a broad term and is used in accordance with its ordinary meaning and may include, without limitation, low range, mid range, and high range high heat transfer materials. Low range high heat transfer materials are materials that have a greater thermal conductivity than iron. For example, low range high heat transfer materials may have a heat conductivity superior to iron and its alloys. High range high heat transfer materials have thermal conductivity greater than the mid range materials. For example, a material that comprises mostly or entirely copper and its alloys can be a high range heat transfer material. Mid range high heat transfer materials have thermal conductivities greater than low range and less than the high range high heat transfer materials. For example, AMPCOLOY® alloys, alloys comprising copper and beryllium, and the like can be mid range high heat transfer materials. In some embodiments, the high heat transfer materials can be a pure material (e.g., pure copper) or an alloy (e.g., copper alloys). Advantageously, high heat transfer materials can result in rapid heat transfer to reduce cycle times and increase production output. For example, the high heat transfer material at room temperature can have a thermal conductivity more than about 100 W/(mK), 140 W/(mK), 160 W/(mK), 200 W/(mK), 250 W/(mK), 300 W/(mK), 350 W/(mK), and ranges encompassing such thermal conductivities. In some embodiments, the high heat transfer material has a thermal conductivity 1.5 times, 2 times, 3 times, 4 times, or 5 times greater than iron.

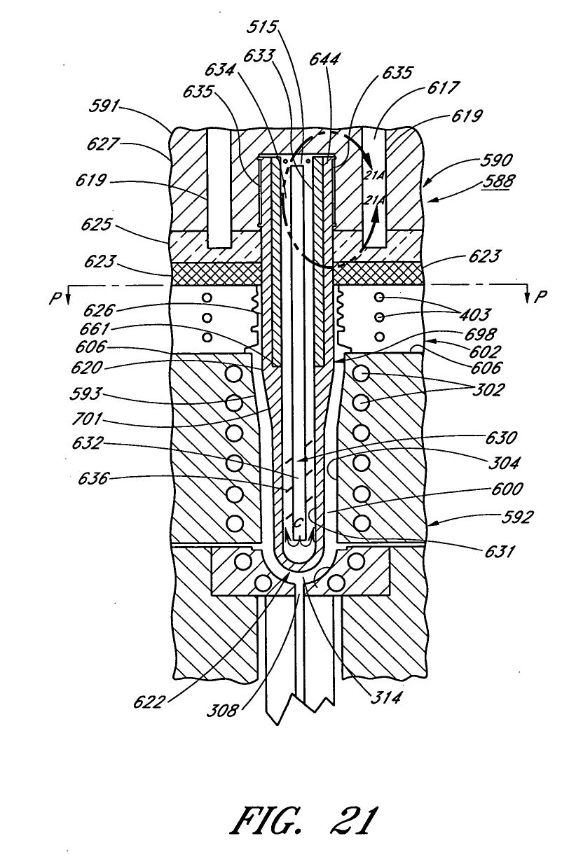

FIG. 19 is a schematic representation of another embodiment of a mandrel, or core 301, including a modified base end 442 or tip. The mold core 301 of FIG. 19 is similar in construction to the mold described above with reference to FIG. 15.

As described above, the end cap portion of the injection molded preform adjacent the base end 322, receives the last portion of the melt stream to be injected into the mold cavity 300. Thus, this portion is the last to begin cooling. If the PET layer has not sufficiently cooled before the overmolding process takes place, the force of the barrier material melt entering the mold may wash away some of the PET near the base end 322 of the core 301. To speed cooling in the base end 322 of the core 301 in order to decrease cycle time, the modified core 301 includes a base end 442 portion constructed of an especially high heat transfer material, preferably a beryllium-free copper alloy, such as AMPCOLOY. Advantageously, the AMPCOLOY base end 442-allows the circulating fluid C to withdraw heat from the injected preform at a higher rate than the remainder of the core 301. Such a construction allows the end cap portion of the preform to cool quickly, in order to decrease the necessary cooling time and, thus, reduce the cycle time of the initial preform injection.

The modified core 301 illustrated in FIG. 19 generally comprises an upper core portion 418, substantially as illustrated in FIG. 15, and a base end portion 442 constructed of a high heat transfer material, including, but not limited to, a beryllium-free copper alloy, such as AMPCOLOY. A core tube 332, substantially as described above, is illustrated in phantom. As in FIG. 15, the present core tube 332 is operable for delivering circulating cooling fluid to the base end 442 of the core 301.

The core 301 is substantially hollow and defines an inner diameter D and wall thickness T. The upper core portion 418 includes a recessed step 420 having a diameter D_{S} which is greater than the inner diameter D of the core 301. The base end portion 422 includes a flange 422 having a diameter D_{F} which is smaller than the diameter D_{S} of the step 420. The difference between the diameters D_{S} and D_{F} of the step 420 and flange 422, respectively, is preferably between 0.000 and 0.025 inches. More preferably, the difference is between 0.010 and 0.015 inches. When the base end portion 442 is placed concentrically within the upper core portion 418, the difference in the diameters D_{S}, D_{F} results in a gap G being formed between the base end and upper core portions 442, 418. The width W of the gap G is approximately equal to one-half the difference between the diameters D_{S}, D_{F}. Additionally, the base end portion 442 is preferably about 0.750-1.250 inches in length.

Preferably, the modified core 301 is constructed by starting with an unmodified core 298 made from a single material, substantially as illustrated in FIG. 15. The end portion, or tip, of the unmodified core 298 is cut off approximately at the point where the high heat transfer base end 442 is desired to begin. A drilling, or boring, tool may then be inserted from the end portion of the core 301 to ensure that the inner diameter D is correctly sized and concentric with a center axis of the core 301. This also ensures that the wall thickness T is consistent throughout the portion of the core 301 which is in contact with the injected preform, thus ensuring that the cooling of the preform is consistent as well. Such a method of construction presents a distinct advantage over conventionally formed cores. In a conventional core, because the length to diameter ratio is large, the drilling tool used to create the hollow inner portion of the core often tends to wander, that is, tends to deflect from the center axis of the core. The wandering of the drilling tool results in a core having an inconsistent wall thickness and, thus, inconsistent heat transfer properties. With the above-described method of sizing the inner diameter D from the base end of the core 301, the problem of tool wandering is substantially reduced or eliminated. Therefore, a consistent wall thickness T and, as a result, consistent heat transfer properties are achieved.

The upper core portion 418 and base end portion 442 are preferably joined by a silver solder process. AMPCOLOY is a preferred material for the base end portion 442 in part because it contains some silver. This allows the silver solder process to provide a joint of sufficient strength to be useful in injection molding applications. Preferably, the soldering process results in a full contact joint. That is, solder material is disposed on all of the mating surfaces (424, 426 and gap G) between the upper core portion 418 and base end portion 442. Advantageously, the provision of the gap G enhances the flow of solder material such that a strong joint is achieved. In addition, the full contact joint is advantageous because it provides for consistent heat transfer properties and high strength. If the soldered joint was not a full contact joint, any air present in the gap G would result in inconsistent heat transfer through the gap G portion of the core 301. Although it is preferred to join the upper core portion 418 and base end portion 442 with a silver solder process, other suitable joining processes may also be used.

As illustrated in FIG. 19, the base end portion 442 of the modified core 301 is preferably of a larger size than the final dimension desired (illustrated by the dashed line 428) when it is joined to the upper core portion 418. Advantageously, this allows for the base end portion 442 to be machined to its desired dimension after assembly to the upper core portion 418 in order to ensure a proper final diameter and a smooth surface at the transfer from the upper core portion 418 to the base end portion 442.

Another way to enhance cooling of the preform's gate area was discussed above and involves forming the mold cavity so that the inner PET layer is thinner at the gate area than at the rest of the injected preform as shown in FIG. 4. The thin gate area thus cools quickly to a substantially solid state and can be quickly removed from the first mold cavity, inserted into the second mold cavity, and have a layer of barrier material injected thereover without causing washing of the PET.

In the continuing effort to reduce cycle time, injected preforms are removed from mold cavities as quickly as possible. However, it may be appreciated that the newly injected material is not necessarily fully solidified when the injected preform is removed from the mold cavity. This results in possible problems removing the preform from the cavity 300. Friction or even a vacuum between the hot, malleable plastic and the mold cavity surface 304 can cause resistance resulting in damage to the injected preform when an attempt is made to remove it from the mold cavity 300.

Typically, mold surfaces are polished and extremely smooth in order to obtain a smooth surface of the injected part. However, polished surfaces tend to create surface tension along those surfaces. This surface tension may create friction between the mold and the injected preform which may result in possible damage to the injected preform during removal from the mold. To reduce surface tension, the mold surfaces are preferably treated with a very fine sanding device to slightly roughen the surface of the mold. Preferably the sandpaper has a grit rating between about 400 and 700. More preferably a 600 grit sandpaper is used. Also, the mold is preferably sanded in only a longitudinal direction, further facilitating removal of the injected preform from the mold.

During injection, air is pushed out of the mold cavity 300 by the injected meltstream. As a result, a vacuum may develop between the injected preform and the mold cavity wall 304. When the injected preform is removed from the cavity 300, the vacuum may resist removal, resulting in damage to the not-fully-solidified preform. To defeat the vacuum, an air insertion system 340 may be employed. With additional reference to FIGS. 16 and 17, an embodiment of an air insertion system 340 is provided. At a joint 342 of separate members of the mold cavity 300, a notch 344 is preferably formed circumferentially around and opening into the mold cavity 300. The notch 344 is preferably formed by a step 346 of between 0.002 inches and 0.005 inches and most preferably about 0.003 inches in depth. Because of its small size, the notch 344 will not fill with plastic during injection but will enable air A to be introduced into the mold cavity 300 to overcome the vacuum during removal of the injected preform from the mold cavity 300. An air line 350 connects the notch 344 to a source of air pressure and a valve (not shown) controls the supply of air A. During injection, the valve is closed so that the melt fills the mold cavity 300 without air resistance. When injection is complete, the valve opens and a supply of air is delivered to the notch 344 at a pressure between about 75 psi and 150 psi and most preferably about 100 psi. The supply of air defeats any vacuum that may form between the injected preform and the mold cavity, aiding removal of the preform. Although the drawings show only a single air supply notch 344 in the mold cavity 300, any number of such notches may be provided and in a variety of shapes depending on the size and shape of the mold.

While some of the above-described improvements to mold performance are specific to the method and apparatus described herein, those of skill in the art will appreciate that these improvements may also be applied in many different types of plastic injection molding applications and associated apparatus. For instance, use of AMPCOLOY in a mold may quicken heat removal and dramatically decrease cycle times for a variety of mold types and melt materials. Also, roughening of the molding surfaces and provides air pressure supply systems may ease part removal for a variety of mold types and melt materials.

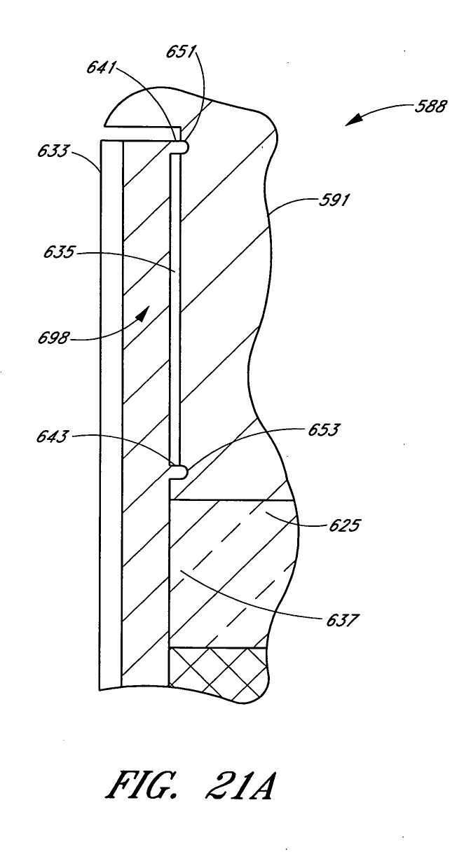

FIG. 20 illustrates an injection mold assembly, similar to those described above, and referred to generally by the reference numeral 500. The injection mold assembly 500 is configured to produce an injection molded, plastic preform. In the illustrated arrangement, the mold 500 utilizes one or more hardened materials to define contact surfaces between various components of the mold 500. As used herein, the term “hardened material” is a broad term and is used in its ordinary sense and refers, without limitation, to any material which is suitable for preventing wear, such as tool steel. In various embodiments, the hardened or wear resistant material may comprise a heat-treated material, alloyed material, chemically treated material, or any other suitable material. The mold 500 also uses one or more materials having high heat transfer properties to define at least a portion of the mold cavity surfaces, as is described in greater detail below. The mold 500 may also utilizes the hardened materials (having generally slower heat transfer properties) to produce a preform having regions with varying degrees of crystallinity, similar to the injection molds described above.

As in the mold arrangements described above, the mold assembly 500 comprises a core section 502 and a cavity section 504. The core section 502 and the cavity section 504 define a parting line P, indicated generally by the dashed line of FIG. 20, between them. The core section 502 and the cavity section 504 cooperate to form a mold cavity 506, which is generally shaped in the desired final shape of the preform. The cavity section 504 of the mold 500 defines a passage, or gate 508, which communicates with the cavity 506. An injection nozzle 510 delivers a molten polymer to the cavity 506 through the gate 508.

Preferably, the core section 502 of the mold 500 includes a core member 512 and a core holder 514. The core holder 514 is sized and shaped to be concentric about, and support a proximal end of, the core member 512. The core member 512 extends from an open end 516 of the core holder 514 and extends into the cavity section 504 of the mold to define an internal surface of the cavity 506 and thus, an internal surface of the final preform. The core member 512 and the core holder 514 include cooperating tapered portions 518, 520, respectively, which locate the core member 512 relative to the core holder 514.

Preferably, the core member 512 is substantially hollow, thus defining an elongated cavity 522 therein. A core tube, or bubbler tube 524, extends toward a distal end of the core cavity 522 to deliver a cooling fluid to the distal end of the cavity 522. As in the previous arrangements, cooling fluid is delivered to the end of the core member 512, and progresses through the cavity 522 toward the base of the core member 512. Preferably, the bubbler tube 524 is CNC machined for greater accuracy. In addition, a plurality of tangs 526 extend radially outward from the body of the bubbler tube 524 and contact the inner surface of the cavity 522 to maintain the tube 524 in a coaxial relationship with the core member 512. Such a construction inhibits vibration of a distal end of the bubbler tube 524, thus improving the dimensional stability of the preforms produced by the mold 500.

The cavity section 504 of the mold 500 generally includes a neck finish mold or threaded finish portion 528, a main cavity section 530 and a gate portion 532. All of these portions 528, 530, 532 cooperate to define an outer surface of the cavity 506, and thus an outer surface of the finished preform produced by the mold 500. The distal end of the core member 512 correlates to the distal end of the cavity 506. The thread finish portion 528 is positioned adjacent the core section 502 of the mold 500 and cooperates with the core section 502 to define the parting line P. The thread finish portion 528 defines the threads 534 and neck ring 536 portions of the cavity 506, and thus of the final preform. Preferably, the thread finish portion 528 comprises two semicircular portions, which cooperate to define the thread finish portion of the cavity 506 so that the thread finish portion 528 may be split apart from one another, in a plane perpendicular to the plane of separation between the core section 502 and cavity section 504, to permit removal of the finished preform from the cavity 506, as is known in the art.

The main cavity section 530 defines the main body portion of the cavity 506. Desirably, the main cavity section 530 also defines a plurality of cooling channels 538, which direct cooling fluid around the main body portion 530 to cool the preform within the cavity 506.

The gate portion 532 of the mold 500 is interposed between the main cavity section 530 and the injection nozzle 510 and defines at least a portion of the gate 508. The gate portion 532 defines one large cooling channel 540, but any number of smaller cooling channels may be alternatively be provided.

The mold 500 defines a number of contact surfaces defined between the various components that make up the mold 500. For example, in the illustrated arrangement, the core section 502, and specifically the core holder 514 defines a contact surface 542 that cooperates with a contact surface 544 of the cavity section 504 and, more specifically, the thread finish portion 528 of the mold 500. Similarly, the opposing side of the thread finish portion 528 defines a contact surface 546 that cooperates with a contact surface 548 of the main cavity section 530.

The corresponding contact surfaces 542, 544 and 546, 548 intersect the mold cavity 506 and, therefore, it is desirable to maintain a sufficient seal between the contact surfaces 542, 544 and 546, 548 to inhibit molten polymer within the cavity 506 from entering between the respective contact surfaces. Preferably, the corresponding contact surfaces 542, 544 and 546, 548 include mating tapered surfaces, generally referred to as taper locks. Due to the high pressure at which molten polymer is introduced into the cavity 506, a large clamp force is utilized to maintain the core section 502 and the cavity section 504 of the mold in contact with one another and maintain a good seal between the contact surfaces 542, 544 and 546, 548. As a result of such a high clamp force, it is desirable that the components of the mold 500 defining the contact surfaces are formed from a hardened material, such as tool steel, for example, to prevent excessive wear to these areas and increase the life of the mold.

Furthermore, as described in detail throughout the present application, it is also desirable that at least a portion of the mold 500 that defines the cavity 506 be made of a high heat transfer material, such as AMPCOLOY. Such an arrangement permits rapid heat withdrawal from the molten polymer within the cavity 506, which cools the preform to a solid state so that the cavity sections 502 and 504 may be separated and the preform removed from the mold 500. As described above, the rate of cooling of the preform is related to the cycle time that may be achieved without resulting in damage to the preform once it is removed from the mold 500.

A decrease in cycle time means that more parts may be produced in a given amount of time, therefore reducing the overall cost of each preform. However, high heat transfer materials that are preferred for at least portions of the molding surface of the cavity 506 are generally too soft to withstand the repeated high clamping pressures that exist at the contact surfaces 542, 544 and 546, 548, for example. Accordingly, if an entire mold were to be formed from a high heat transfer material, the relatively short life of such a mold would not justify the decrease in cycle time that may be achieved by using such materials. The illustrated mold 500 of FIG. 20, however, is made up of individual components strategically positioned such that the contact surfaces 542, 544 and 546, 548 comprise a hardened material, such as tool steel, while at least a portion of the mold 500 defining the cavity 506 comprises a high heat transfer material, to reduce cycle time.

In the illustrated embodiment, the core holder 514 is desirably constructed of a hardened material while the core member 512 is constructed from a high heat transfer material. Furthermore, the thread finish portion 528 of the mold desirably is constructed of a hardened material. The main cavity section 530 preferably includes a hardened material portion 530a and a high heat transfer material portion 530b. The hardened material portion 530a could be made from the same material the thread finish portion 528. The hardened material portion 530a could be made from a different material than the thread finish portion 528. Preferably, the hardened material portion 530a defines the contact surface 548 while the high heat transfer material portion 530b defines a significant portion of the mold surface of the cavity 506. The high heat transfer material portion 530b and the gate portion 532 may be made from the same or different material. The hardened material portion 530a and the high heat transfer material portion 530b of the main cavity section 530 may be coupled in any suitable manner, such as a silver soldering process as described above, for example. Furthermore, the gate portion 532 of the mold 500 is also desirably formed from a high heat transfer material, similar to the molds described above.

In one embodiment, the thread finish portion 528 comprises a contact portion 802 coupled to a threaded insert 801. The contact portion 802 is positioned adjacent the core section 502 of the mold 500 and cooperates with the core section 502 to define the parting line P. Preferably, the contact portion 802 is made from a hardened material, such as tool steel. The threaded insert 801 can define the threads 534 and the neck ring 536 portion of the cavity 506. The threaded inserts 801 can be coupled to the contact portion 802 and can be formed from a high heat transfer material. Of course, the threaded insert 801 and the contact portion 802 can form a portion of the threads 534 and/or neck ring 536 and the proximal end of the cavity 506.

With a construction as described above, advantageously the mold 500 includes hardened materials at the contact surfaces 542, 544 and 546, 548 to provide a long life to the mold 500. In addition, the mold 500 also includes high heat transfer materials defining at least a portion of the molding surfaces of the cavity 506 such that cycle times may be reduced and, therefore, through-put of the mold 500 is increased. Such an arrangement is especially advantageous in molds designed to form preforms, which are later blow molded into a desired final shape.

Another benefit of the mold 500 is that the hardened material thread finish portion 528 has a lower rate of heat transfer than the high heat transfer portions of the mold 500. Accordingly, the neck finish of the preform may become semi-crystalline or crystalline, which allows the neck finish to retain it's formed dimensions during a hot-fill process. Furthermore, the portion of the core member 512 adjacent the thread finish portion 528 is preferably high heat transfer material, which rapidly cools the inner surface of the thread finish of the preform, thereby allowing the preform to maintain it's formed dimensions when removed from the mold in a less than fully cooled state. The cycle time may be reduced from 15%-30% utilizing a mold construction such as mold 500 in comparison with a mold made from conventional materials and construction techniques. In addition, certain portions of the mold 500 may be replaced, without necessitating replacement of the entire mold section. For example, the core member 512 and core holder 514 may be replaced independently of one another.

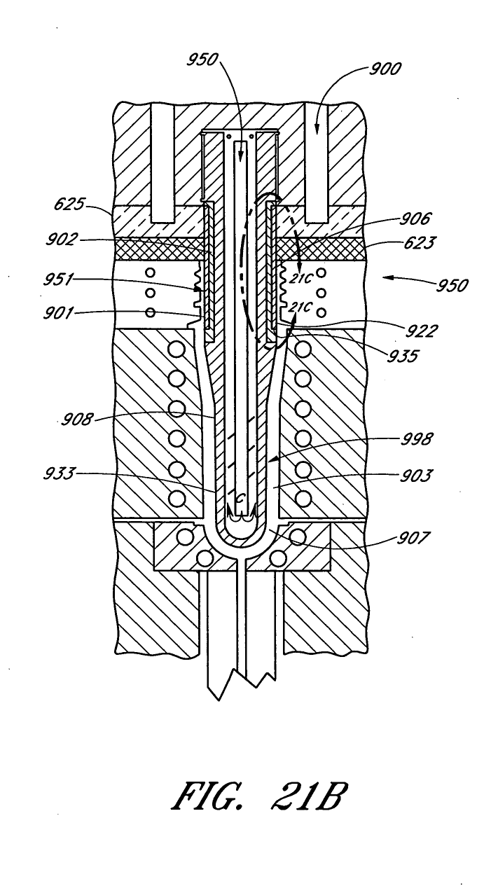

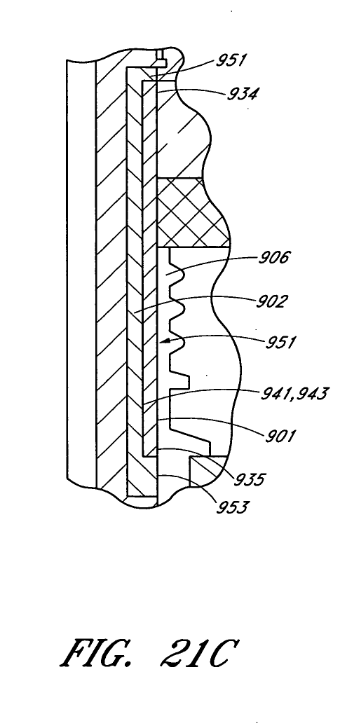

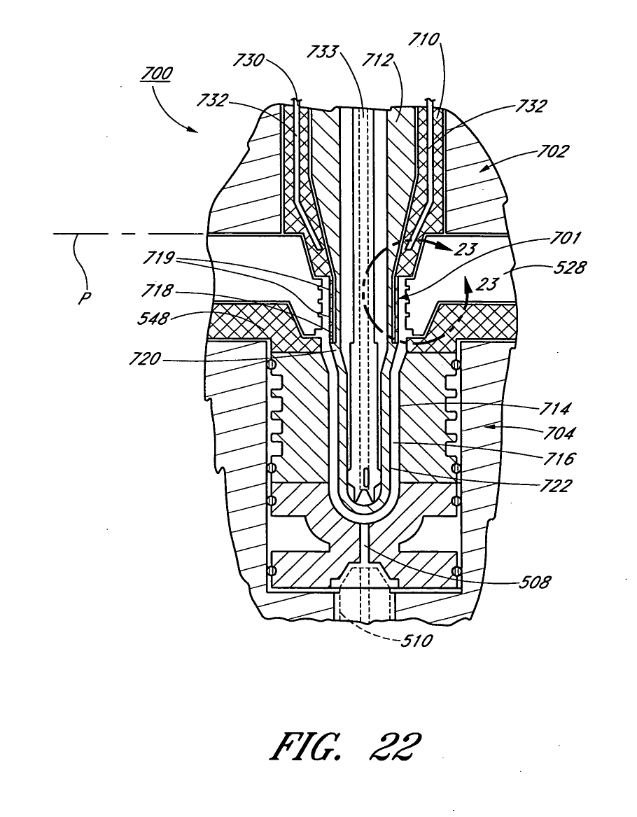

With reference to FIG. 21, a preferred embodiment of the mold 588 having a core section 590 and cavity section 592 is depicted. The mold 588 can heat and/or cool different portions of molten material to form crystalline (including semi-crystalline) material and amorphous material. That is, the thermal characteristics of the mold can be designed for crystallization of at least a portion of a preform. The crystallization process can be performed when the mold is closed, partially opened, and/or fully opened. The depth and rate of crystalline growth at the outer surfaces of the molded article can be varied as desired. To maintain molding surfaces of the mold 588 at different temperatures, components of the mold 588 can be thermally isolated. The components of the illustrated embodiment are identified with the same reference numerals as those used to identify corresponding components of the molds described above.

The illustrated core section 590 has a core holder 591 holding an elongated molding assembly or core 698 disposed within an associated mold cavity 593 of the cavity section 592. Generally, separate portions of the core holder 591 can be maintained at specific temperatures to form an article with desired material characteristics. To form crystalline material, the core holder 591 can be at a sufficiently high temperature to induce crystallization of melt injected into the mold 588. In such embodiments, the core holder 591 and core 698 can be used to keep the temperature of the hot melt above the minimum temperature of crystallization so as to form crystalline material. This region of the core 698 can mold a portion of a preform, preferably the neck finish portion of the preform thereby producing a crystalline or semi-crystalline neck finish. The portion of the core 698 molding the body of the preform can be rapidly cooled, thus producing a generally amorphous body portion of the preform. Accordingly, the upper portion of the core 698 can be a relatively high temperature (preferably above a crystallinity temperature of the resin) for forming crystalline material while the lower portion of the core 698 forms amorphous material.

The mold 588 has a mold temperature control system 515 for accurately maintaining portions of the mold 588 at different temperatures. The mold temperature control system 515 can comprises one or more independent temperature control systems. The illustrated mold temperature control system 515 includes a core holder temperature control system 617 for selectively controlling the temperature of the core holder 591. In some embodiments, the core holder 591 comprises high heat transfer material positioned so that heat can be quickly transferred between the temperature control system 617 and the core 698. The temperature control system 515 also includes another temperature control system 630 that is disposed within the core 698 and spaced from the temperature control system 617. The illustrated temperature control system 630 is a fluid cooling arrangement extending through the core 698.

With continued reference to FIG. 21, a void space 600 is defined by the core 698 and the mold cavity 593 and has a shape corresponding to the shape of a preform. The core 698 can have a neck molding surface 626 and a body molding surface 701. The neck molding surface 626 is adapted for molding the interior portion of the neck portion 32. The body molding surface 701 is adapted for molding the interior portion of the body portion 32.

The core 698 is hollow and has a wall 620 of a generally uniform thickness that surrounds the fluid cooling arrangement 630. At least a portion of the wall 620 can comprise a material with especially high heat transfer properties. In some embodiments, high heat transfer material may be disposed over substantially the entire surface area of the core 698. The high heat transfer material in some embodiments may comprise AMPCOLOY or similar material. The high heat transfer material can be coated onto the core 698 or can form the entire wall 620. The high heat transfer material of the core 698 allows for rapid temperature changes and, thus, assists in achieving lower cycle times. In some alternative embodiments, the wall 620 can be made of a low heat transfer material, but the heat load capabilities of the core 698 may be reduced. However, some low heat transfer materials may have superior structural properties that reduce deflection of the core 698 for improved tolerances and mold life.

The core 698 and the core holder 591 can have complementary structures designed to reduce or avoid relative movement between the core 698 and the holder 591. As illustrated in FIG. 21A, the core 698 and the core holder 591 can have a male/female interface. The illustrated core 698 has a pair of flanges 641, 643 that are received within corresponding recesses 651, 653. The flanges 641, 643 and corresponding recesses 651, 653 cooperate to avoid relative movement between the core 698 and the holder 591, especially while the melt is injected into the void space 600 and during ejection of the preform from the core 698. In one embodiment, the flanges 641, 643 and recesses 651, 653 are sized so that the portion of core 698 between the flanges 641, 643 is spaced from the core holder 591 and defines a pocket. The pocket can be filled with air which acts as a thermal barrier. Insulating materials can also be sandwiched between the core 698 and the core holder 591. The insulating material can inhibit heat transfer between a portion of the core 698 and a portion of the core holder 591. Other types of means for inhibiting heat transfer may also be utilized, if desired.

Other types of coupling arrangements can also be employed to hold the core 698 in the core holder 591. Ribs, pins, and other types of mounting structures can be used hold the core 698 in the core holder 591. These coupling arrangements may or may not include a means for inhibiting heat transfer between the core 698 and the core holder 591 depending on the application.

With reference again to FIG. 21, the core temperature control system 630 and the core holder temperature control system 617 can cooperate to maintain a desired temperature distribution in the mold 588. In some embodiments, the cooling arrangement 630 rapidly cools the body molding surface 701 of the core 698 while the temperature control system 617 keeps the neck molding surface 626 at a relatively high temperature for forming crystalline material. The fluid cooling arrangement 630 disposed within the core 698 can deliver a cooled or chilled fluid through the tube 632 directly to the base end 622 of the core 698. The chilled fluid can pass out of the opening of the tube 632 and then proceeds up through the core 698 between the outer surface of the tube 632 and the inner surface 631 of the wall 620. As the chilled fluid proceeds up the core 698, heat is transferred from the wall 620 to the fluid, thereby reducing the temperature of the wall 620.

The working fluid of the fluid cooling arrangement 630 can be a liquid and/or gas. In the illustrated embodiment, a cool gas (e.g., refrigerant, nitrogen (N2), cryogenic fluid, and the like) can be delivered by the fluid cooling arrangement 630 to cool the core 698. Advantageously, the combination of the cooling gas and high heat transfer material of the core 698 allows reduced dimensions of the fluid cooling arrangement 630, thus permitting an increased thickness of the wall 620 for increased rigidity. The increased rigidity of the core 698 can ensure that the surface of the core 698 is generally concentric with the surface 304 of the cavity section 592. The concentric surfaces preferably result in production of preforms that have generally uniform wall thicknesses. Moreover, the fluid cooling arrangement 630 having gas as the working fluid can rapidly cool melt in the cavity 600 to reduce production cycle times. In alternative embodiments, the fluid cooling arrangement 630 can use chilled water as a working fluid. The temperature control system 630 can be a fluid cooling arrangement, heat/cooling tube, or other system suitable for selectively controlling the temperature of a core.

With continued reference to FIG. 21, the core 698 can have an insulator 633 for reducing heat transfer between the core 698 and the core holder 591. Thermal isolation along the core 698 can result in temperature distributions along the core suitable for forming varying degrees of crystallinity. The insulator 633 can inhibit heat transfer between the fluid flowing through the core 698 and the injected melt so that the surfaces of the core 698 can be maintained at significantly different temperatures, if desired. The insulator 633 can also inhibit heat transfer between the core holder 591 and the working fluid core 698.

The insulator 633 can be an insert, coating, or other suitable structure for reducing heat transfer through the wall 620 of the core 698. The illustrated insulator 633 can minimize the heat transfer from an upper portion 634 of the core 698 to adjacent portions of the core holder 591. In some embodiments, including the illustrated embodiment of FIG. 21, the insulator 633 effectively inhibits heat transfer between the working fluid of the core 698 and a core holder heat transfer element 625. In some embodiments, the insulator 633 comprises stainless steel, phenolic, and/or other suitable material having a low thermal conductivity for enhancing thermal isolation of fluid flowing through the core 698.

The illustrated insulator 633 is a tubular member that extends along the interior surface of the core 698. A lower end 661 of the insulator 633 is positioned near the region of the void 600 that forms the junction of a neck finish and a body portion of a preform. However, the lower end 661 of the insulator 633 can also be positioned at other locations.

Heat can be conducted between the core holder 591 and melt injected into the neck finish region of the cavity 600 via the core holder heat transfer element 625. The core holder heat transfer element 625 can be a plate that comprises a material having thermal properties suitable for effectively transferring heat between the core 698 and the temperature control system 617. For rapid heat transfer, the core holder heat transfer element 625 can be made of a high heat transfer material. In such embodiments, heat can be rapidly transferred between the temperature control system 617 and the neck molding surface 626 of the core 698. In alternative embodiments, the core holder heat transfer element 625 can be made of steel, low heat transfer materials, and the like.

The core holder heat transfer element 625 of FIG. 21 preferably defines a surface that matches and engages the outer surface of the core 698. The illustrated element 625 is interposed between a split ring 623 and an upper portion 627 of the core holder 591. The size of the contact region 637 (FIG. 21A) between the element 625 and the core 698 can be increased or decreased to increase or decrease, respectively, the heat flow between the element 625 and the core 698. Additionally, the amount of heat produced or absorbed by the temperature system 617 can be adjusted to achieve the desired temperature of the mold surfaces. Advantageously, the element 625 can efficiently transfer heat with the core 698 such that the neck molding surface 626 of the core 698 has a generally uniform temperature distribution. Of course, the body molding surface 701, located below the neck finish surface 626, may be at significantly lower temperature then the neck molding surface 626.

The temperature control system 617 can comprise one or more heating elements, such as heating/cooling rods, fluid channels, etc. In the illustrated embodiment, the temperature control system 617 comprises a plurality of heating rods 619 embedded in the core section 590. Each of the rods 619 extends through the core section 590 and terminates near the split ring 623 of the core section 590. Alternatively, the temperature control system 617 can comprise heating coils, heating probes, electric heaters, and/or heating channels for controlling the temperature of the core section 590.

In yet other embodiments, the temperature control system 617 is a fluid system for running a working fluid. The illustrated core holder 591 can have channels 619 for fluid flow therethrough. To control the temperature of the element 625, fluid flows through the channels 619 and eventually along the portions of the channels 619 defined by the element 625. Heat can then be rapidly transferred from the element 625, which has absorbed heat from the core 698, to the working fluid. To improve heat transfer to the fluid, the element 625 can comprise a high heat transfer material, although other materials can also be utilized. The other portions of the core holder 591 can be made of heat treated tool steel (e.g., P-20, H-13, stainless steel, and the like). One of ordinary skill in the art can determine the appropriate type of heating elements or devices to achieve the desired temperature distribution of the surfaces of the mold.

The temperature control system 617 can actively heat and/or cool the core holder 591, which may comprise a low thermally conductive material. As used herein, the term “actively” is a broad term and includes, without limitation, capable of taking action to control temperatures. Some temperature control systems can actively absorb and remove heat from an article at a rate higher than heat merely flowing through a mold material. In addition, temperature control systems can also output thermal energy, if desired. Temperature control systems can thus actively heat or cool material at variable cooling rates. Additionally, active temperature control systems can be used for accurately controlling temperatures of molding surfaces. Passive cooling can also be employed to cool the melt. Passive cooling can be achieved by utilizing materials having different thermal properties.

The split ring 623 can hold the core holder heat transfer element 625 in place. Couplers can be used to attach the split ring 623 and the core holder heat transfer element 625 to the upper portion 627. By way of example, couplers in the form of bolts can pass through and attach the split ring 623 and the element 625 to the upper portion 627. The thermal elements 619 can be located between these bolts. Additionally, the split ring 623 can hold the core 698 in a desired position. Frictional engagement between the split ring 623 and the core 698 can inhibit or prevent axial movement and/or lateral movement of the core 698.

The mold 588 illustrated in FIG. 21 can produce complete or partial crystallization of the neck finish of the preform formed in the cavity 600. The mold 588 can thus be used to make preforms having crystalline or semi-crystalline neck finishes, such as the preforms described above. The temperature of the fluid flowing through the core 698, the amount of energy produced/absorbed by the temperature control system 617, the materials and configuration of the mold 588, and/or the flow rate and temperature of the fluid passing through the channels 403 can be chosen to produce various types of preforms.

To mold a preform, melt can be injected through the line and through the gate 308 and into the cavity 600. The temperature control system 617 and the fluid cooling arrangement 630 can work alone or in combination to cool the body portion 34 to form non-crystalline material. When the cavity 600 is filled, the resin in the mold 588 contacts the neck molding surface 626 and the surface of the neck finish mold 602. The neck finish of the preform contacting these surfaces can be maintained at a relatively high temperature to form crystalline material. The higher temperature of the neck finish is needed to promote the crystallization process. In some embodiments, the neck finish of the preform can be slowly cooled to increase its degree of crystallinity. Alternatively, the neck finish of the preform can be rapidly cooled after reaching a desired degree of crystallinity. Thus, the neck finish can be maintained at a relatively high temperature for crystallization and then rapidly cooled a sufficient amount to produce a dimensionally stable preform.

In some embodiments, the mold 588 can produce monolayer preforms that are subsequently blow molded into containers. In other embodiments, the preform formed in the mold 588 can be placed in another mold cavity for overmolding to form a multilayer preform. For example, the preform formed in the mold 588 can be placed in the mold half 92 of FIG. 7 for overmolding. During the overmolding process, the core 698 can crystallize the neck finish of the preform. After the preform has been overmolded, the preform can be rapidly cooled for ejection.

There can also be thermal isolation of the neck finish mold 602 from the mold cavity 600 by using one or more inserts 606 which preferably have a low thermal conductivity. The inserts 606 provide a thermal barrier about the neck finish mold 602 as described above.

In certain embodiments, the neck finish mold 602 is generally at temperature of about 160-200° F. while the inserts 606 act as a thermal barrier such that the body mold is generally at a temperature of 45° F. when the injected resin comprises PET. The neck molding surface 626 of the core 698 is also preferably at a temperature of about 160-200° F., while the body molding surface 701 is at a significantly lower temperature, preferably below the crystallization temperature of the injected material. Of course, the processing temperatures may vary depending on the resin's properties and preform configuration.

The temperature of the neck finish mold 602 can vary between the inserts 606 and the core holder 591. Alternatively, the neck finish mold 602 can have a somewhat constant temperature profile. Fluid can be run through the channels 403 of the neck finish mold to further enhance the crystallization process. As such, the heated neck finish mold 602 can enhance crystallization of the preform.

The mold 588 can produce the preforms described above. By way of example, the preform of FIG. 2A can be formed by rapidly cooling the inner portion of the neck finish 32 with the core 698 while keeping the neck finish mold 602 at a relatively high temperature for crystallizing the outer portion of the neck finish 32 of the preform. The preform of FIG. 2B can be formed by maintaining the neck molding surface 626 of the core 698 and neck finish mold 602 at temperatures sufficiently high for causing crystallization of the injected material. Similar, the core 698 and the neck finish mold 602 can be used to rapidly or slowly cool material to form the amorphous or non-amorphous material of the preforms of FIGS. 2C-2E.

After the material injected into the mold 588 is sufficiently stable, the mold 588 can be opened. The preform can be retained on the core 698 after the mold 588 is opened to further process the preform. If desired, the preform can undergo further crystallization after the mold 588 has been opened. If the preform is coated by the overmolding process described above, the preform remains on the core 698 during the subsequent overmolding process. The preform can undergo crystallization during at least a portion of the overmolding process. The inject-over-inject process can be used to manufacture multilayer preforms having a crystalline or semi-crystalline neck finish without an appreciable increase in production cycle time.

FIG. 21B illustrates an alternative embodiment of a mold for producing preforms with a crystalline or semi-crystalline neck portion. The mold 950 includes an elongated molding assembly or core 998 that has a thermally isolated upper core portion 951 that defines a heat flow path between a void space 903 and a temperature control system 900. The temperature control system 900 positioned in the core holder can control the temperature of the resin contacting the upper core portion 951. The mold 950 is generally similar to the mold 588 of FIG. 21, except as detailed below.

The upper core portion 951 extends along the periphery of a main core body 908, and comprises an upper core insert 901 and an insulating member 902. The insulating member 902 is interposed between the main core body 908 and the upper core insert 901 in order to thermally isolate the insert 901 from the main core body 908.

The upper core insert 901 has a neck molding surface 922 for molding an inner surface of a neck portion of a preform. The upper core insert 901 can be comprised of high heat transfer material so that heat can be rapidly transferred between the temperature control system 900 and resin injected into the mold 950. The member 625 provides a heat flow path between the insert 901 and the temperature control system 900. The upper core insert 901 is a somewhat tubular member that extends along the periphery of the core 998, although the insert 901 can have other configurations. The thickness of the upper core insert 901 can be increased to reduce thermal resistance between the resin the insert 901.

With reference to FIG. 21C, a lower end 935 of the upper core insert 901 terminates at a position corresponding to the bottom of the neck finish. An inner surface 941 of the upper core insert 901 mates with an outer surface 943 of the insulating member 902. The insulating member 902 limits heat transfer between the upper core insert 901 and the main core body 908.

The insulating member 902 ensures that the upper core insert 901 is thermally isolated from other regions of the core 998. As such, the temperature of the resin in a neck finish area 906 of the void space 903 can be controlled independently from the body portion 907 of the void space 903. The insulating member 902 preferably has a thermally conductivity that is less than the thermal conductivity of the upper core portion 901. For example, the insulator member 902 can be made of a low heat transfer material while the upper core insert 901 is made of a high heat transfer material. In such an embodiment, the insulating member 902 inhibits heat transfer between the upper core insert 901 and the main core body 908.

The thermal insulating member 902 is a somewhat tubular member extending between the insert 901 and the core main body 908. The insulating member 902 has an upper flange 951 and a lower flange 953. The upper and lower flanges 951, 953 extend between upper and lower ends 934, 935, respectively, of the insert 901. Alternatively, the upper core portion 951 may not have a thermal insulating member; that is, the insert 901 may be in direct contact with the core main body 908.

The main core body 908 is in thermal communication with a core temperature control system, 950. In some embodiments, the main core body 908 is comprised of high heat transfer material so for rapid heat between the resin filling the body portion 907 of the void cavity 903. However, other materials can also be used.

When melt is injected to void cavity 903, the resin filling the neck portion region 906 of the cavity 903 can be maintained at a high temperature by heat flowing through the insert 901 and the member 625. The neck molding surface 922 can be maintained at or above the crystallization temperature for the resin until the desired amount of crystallization has occurred. Then the resin in the neck portion 906 can be quickly cooled for subsequent processing. This resin transfers substantially all of its heat lost while cooling through the upper core insert 901 to the temperature control system 900 via the element 625. Because the insulating member 902 insulates the inert 901, the neck finish surface 922 can be at a relatively high temperature as compared to the body molding surface 933. Accordingly, formation of the crystalline material is localized to the melt located at the neck finish mold area 906.

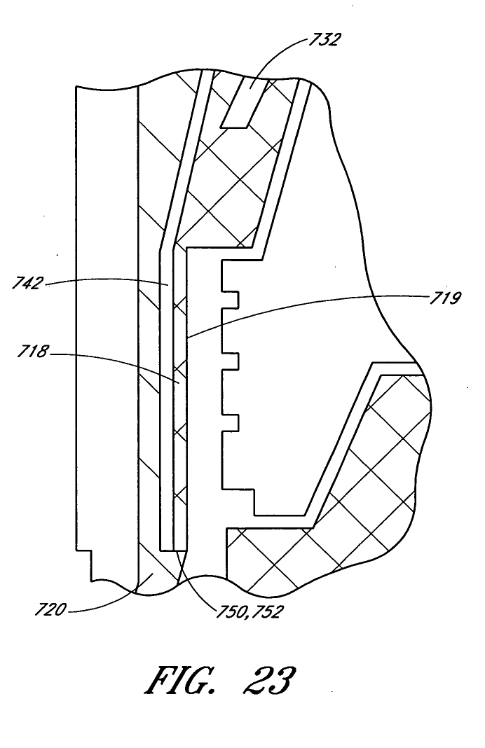

FIG. 22 illustrates a mold 700 comprising a core section 702 and a cavity section 704. The core section 702 has an elongated molding assembly 701 configured to mold an interior region of a preform. The illustrated elongated molding assembly 701 includes a core holder 710 holding a core 712 disposed within an associated mold cavity 714 of the cavity section 704. A core section temperature control system 730 is adapted to control the temperature of the core holder 710. The core holder 710 can mold at least a portion of the preform, and preferably causes crystallization of that portion of the preform.

In the illustrated embodiment, the core holder 710 has a core holder neck molding portion 718 that extends along the core 712. The neck molding portion 718 defines a neck molding surface 719 for molding an interior surface of a neck finish of a preform. The neck molding portion 718 can be used to produce a crystallization neck finish. The components of the illustrated embodiment are identified with same reference numerals as those used to identify corresponding components of the mold illustrated in FIG. 20.

A void space 716 is defined by the core 712 and the mold cavity 714 and has a shape corresponding to the shape of a preform. The core holder 710 is sized and shaped to be concentric about, and support a proximal end of, the core 712. The core holder 710 extends along the upper portion of the core 712 and narrows to form the neck finish portion 718.

As shown in FIGS. 22 and 23, the neck molding portion 718 has a cylindrical configuration and surrounds the core 712. The portion of the core 712 extending downwardly from the neck molding portion 718 can be maintained at a different temperature than the neck molding portion 718. The core 712 preferably has a recess adapted to receive at least a portion of the neck molding portion 718. The illustrated neck molding portion 718 is generally flush with the core 712.

The neck molding surface 719 corresponds to the portion of the mold that forms at least a portion of a neck finish of a preform. For example, the neck molding surface 719 can be configured and sized to mold the interior surface of a neck finish and a portion of the body portion of a preform. The length of the molding surface 719 can be chosen based on the desired size of the region of the molded preform that comprises crystalline material.

In some embodiments, the neck molding portion 718 can define a neck molding surface 719 that corresponds to the neck finish of a preform, as illustrated in FIG. 23. That is, the length of the neck molding portion 718 is generally the same as the length of the neck finish a preform. In yet another embodiment, the neck molding portion 718 defines the surface 719 that defines only a portion of the neck finish of a preform.

The core holder 710 has the temperature control system 730 that preferably comprises one or more heating/cooling elements, such as heating rods. In the illustrated embodiment, the temperature control system 730 comprises a plurality of heating/cooling rods 732 spaced from the core 712. Each of the rods 732 extends through the core holder 710 and terminates near the neck molding portion 718. Although not illustrated, one or more of the rods 732 can extend into and terminate in the neck mold portion 718. Alternatively, the temperature control system 730 can comprise other elements for actively heating and/or cooling the neck mold portion 718. The temperature control system 730 can be similar to the temperature control system 617 of FIG. 21 and therefore will not be discussed in detail.

Various types of materials can be used to form the core holder 710. For example, portions of the core holder 710 may comprise a low heat transfer material and other portions may comprise a high heat transfer material. In some embodiments, the core holder 710 can comprise high heat transfer material for efficient heat transfer with the melt that touches the core holder 710. The high heat transfer material can define heat flow paths through the core holder between any heating/cooling elements disposed therein and a molded material in the cavity 716.

The core 712 is hollow and surrounds the core temperature control system 733. This core temperature control system 733 can be similar to or different than the cooling arrangement in FIG. 20. The fluid cooling arrangement 733 preferably delivers gas that cools the wall 720 of the core 712 so that the thickness of the wall 720 can be maximized.

At least a portion of the wall 720 can comprise a material with especially high heat transfer properties. A high heat transfer material can be disposed over substantially the entire area of the core 712. The high heat transfer material may comprise AMPCOLOY or similar material. The high heat transfer material can be coated onto the core 712 or can form the wall 720. In some embodiments, low thermal conductivity materials form the recess or portion of the core 712 near the core holder 710. For enhanced thermal isolation of the core holder 710, the portions of the core 712 that engage the core holder 710 can be comprised of a low thermal conductivity material. In yet other embodiments, the core 712 can be made entirely of a high heat transfer material.

With reference to FIG. 23, an insulator 742 can be disposed between at least a portion of the core holder 710 and the core 712. The insulator 742 can be similar to the insulator 635 of FIG. 21. If desired, the insulator 742 can be a space between the core holder 710 and the core 712 that is filled with air. The insulator 742 can reduce the heat transfer between the neck molding portion 718 and the core 712, thus providing thermal isolation of the neck finish molding region. The insulator 742 can be an insert or other suitable structure for inhibiting heat transfer. In some embodiments, the insulator 742 may be a coating of an insulating material that is applied to the outer surface of the core 712. Alternatively, the core 712 and the core holder 710 may mate and directly contact each other, but such an arrangement may reduce thermal isolation between the core 712 and the core holder 710.

Although not illustrated, there can be an insulator between the lower surface 750 of the neck molding portion 718 and the upper surface 752 of the core 712. Thus, there can be large temperature differences between the bottom of the molding portion 718 and the adjacent portion of the core 712.

With reference again to FIG. 22, the neck finish mold 528 is optionally heated to further promote crystallinity of the outer regions of the neck finish of a preform. The neck finish mold 528 can have heating channels or other suitable heating means. Alternatively, the neck finish mold 528 can be cooled to reduce crystallinity of the outer portion of the neck finish of the preform. The thread neck finish mold 528 and the core 712 can be used in combination to achieve various types of neck finishes.

The mold 700 illustrated in FIG. 22 can produce complete or partial crystallization of the neck finish of the preform in the cavity 716. The mold 700 can be used to make preforms having crystalline or semi-crystalline neck finishes, such as the preforms described above. One of ordinary skill in the art can adjust the temperature of the fluid flowing through the core 712, the amount of energy produced and/or absorbed by the temperature control system 730, the materials and configuration of the mold 700, and/or the temperature of the neck finish mold 528 to form a preform with the desired crystalline character.

To produce a preform in the mold 700, melt can be injected through the line and through the gate and into the cavity 716 to form a preform. The core holder temperature control system 730 and the fluid cooling arrangement 733 can work alone or in combination to cool the body portion 34 of the preform while achieving a higher temperature of the neck finish surface 719. The resin contacting the neck molding surface 719 is preferably crystallized while the resin contacting the core 712 forms amorphous material.

Pulse cooling can be utilized with the molds described above. After a desired amount of crystallinity is achieved, pulse cooling can be used to rapidly cool the preform to a sufficiently low temperature for dimensional stability of the preform. In some embodiments, when the moldable material is disposed in the mold, chilled fluid (e.g., a refrigerant, cryogenic fluid, etc.) can circulate through mold channels to cool the moldable material. After the preform is cooled, the fluid flow through the mold can be reduced or stopped. Pulse cooling can be used to cool the cores, neck finish portion, and/or the cavity section of the mold. In addition, the embodiments, features, systems, devices, materials, methods and techniques described herein may, in certain embodiments, be applied to or used in connection with any one or more of the embodiments, features, systems, devices, materials, methods and techniques disclosed in the above-mentioned U.S. application Ser. No. 11/149,984, filed on Jun. 10, 2005.

Accordingly, the molds described herein can reduce the rate of cooling of the injected molten melt to increase the amount of crystalline material forming a preform. Of course, the melt can be rapidly cooled to form generally amorphous portions of the preform.

F. Formation of Preferred Containers by Blow Molding

The containers preferably produced by blow-molding the preforms, the creation of which is disclosed above. The uncoated and coated preforms can be blow-molded using techniques and conditions very similar to those by which typical PET preforms are blown into containers. In other preferred embodiments in which it is desired for the entire container to be heat-set, it is preferred that the containers be blow-molded in accordance with processes generally known for heat set blow-molding, including, but not limited to, those which involve orienting and heating in the mold, and those which involve steps of blowing, relaxing and reblowing.

For example, for preforms in which the neck finish is formed primarily of PET, the preform is heated to a temperature of preferably 80 to 120° C., with higher temperatures being preferred for the heat-set embodiments, and given a brief period of time to equilibrate. After equilibration, it is stretched to a length approximating the length of the final container. Following the stretching, pressurized air is forced into the preform which acts to expand the walls of the preform to fit the mold in which it rests, thus creating the container.

All patents and publications mentioned herein are hereby incorporated by reference in their entireties. Except as further described herein, certain embodiments, features, systems, devices, materials, methods and techniques described herein may, in some embodiments, be similar to any one or more of the embodiments, features, systems, devices, materials, methods and techniques described in U.S. Pat. Nos. 6,109,006; 6,808,820; 6,528,546; 6,312,641; 6,391,408; 6,352,426; 6,676,883; U.S. patent application Ser. No. 09/745,013 (Publication No. 2002-0100566); Ser. No. 10/168,496 (Publication No. 2003-0220036); Ser. No. 09/844,820 (2003-0031814); Ser. No. 10/090,471 (Publication No. 2003-0012904); Ser. No. 10/395,899 (Publication No. 2004-0013833); Ser. No. 10/614,731 (Publication No. 2004-0071885), provisional application 60/563,021, filed Apr. 16, 2004, provisional application 60/575,231, filed May 28, 2004, provisional application 60/586,399, filed Jul. 7, 2004, provisional application 60/620,160, filed Oct. 18, 2004, provisional application 60/621,511, filed Oct. 22, 2004, and provisional application 60/643,008, filed Jan. 11, 2005, U.S. patent application Ser. No. 11/108,342 entitled MONO AND MULTI-LAYER ARTICLES AND COMPRESSION METHODS OF MAKING THE SAME, filed on Apr. 18, 2005, U.S. patent application Ser. No. 11/108,345 entitled MONO AND MULTI-LAYER ARTICLES AND INJECTION METHODS OF MAKING THE SAME, filed on Apr. 18, 2005, U.S. patent application Ser. No. 11/108,607 entitled MONO AND MULTI-LAYER ARTICLES AND EXTRUSION METHODS OF MAKING THE SAME, filed on Apr. 18, 2005, which are hereby incorporated by reference in their entireties. In addition, the embodiments, features, systems, devices, materials, methods and techniques described herein may, in certain embodiments, be applied to or used in connection with any one or more of the embodiments, features, systems, devices, materials, methods and techniques disclosed in the above-mentioned patents and applications.

Although the present invention has been described herein in terms of certain preferred embodiments, and certain exemplary methods, it is to be understood that the scope of the invention is not to be limited thereby. Instead, Applicant intends that variations on the methods and materials disclosed herein which are apparent to those of skill in the art will fall within the scope of Applicant's invention.

The materials, methods, ranges, and embodiments disclosed herein are given by way of example only and are not intended to limit the scope of the disclosure in any way. A skilled artisan will recognize the interchangeability of various features from different embodiments disclosed herein. Similarly, the various features and steps discussed above, as well as other known equivalents for each such feature or step, can be mixed and matched by one of ordinary skill in this art to preform methods in accordance with principles described herein. Additionally, the methods which is described and illustrated herein is not limited to the exact sequence of acts described, nor is it necessarily limited to the practice of all of the acts set forth. Other sequences of events or acts, or less than all of the events, or simultaneous occurrence of the events, may be utilized in practicing the embodiments of the invention.

What is claimed is:

1. An apparatus for molding a preform, the apparatus comprising:
a core section having an elongated molding assembly configured to mold at least a portion of the preform, the elongated molding assembly comprising:
a first portion of the elongated molding assembly for molding a first portion of the preform;
a first temperature control system in thermal communication with the first portion;
a second portion of the elongated molding assembly for molding a second portion of the preform; and
a second temperature control system in thermal communication with the second portion;
a cavity section having a cavity, the cavity section and the core section mate to form a cavity space in the shape of the preform, the cavity space positioned between the elongated molding assembly and the cavity; and
wherein the first temperature control system actively controls the temperature of the first portion and the second temperature control system actively controls the temperature of the second portion such that the first portion is at a first temperature for forming crystallized material of the preform while the second portion is at a second temperature for forming substantially amorphous material of the preform.

2. The apparatus of claim 1, wherein the first portion of the elongated molding assembly is positioned to form an interior surface of a neck finish of the preform.

3. The apparatus of claim 1, wherein the second portion of the elongated molding assembly is positioned to form an interior surface of a body portion of the preform.

4. The apparatus of claim 1, wherein the elongated molding assembly is a core that surrounds the second temperature control system which comprises a cooling tube.

5. The apparatus of claim 1, wherein the core section comprises a core holder, and the core holder comprises the first portion which extends along a core of the elongated molding assembly.

6. The apparatus of claim 5, wherein the first portion defines a neck molding surface for molding an interior surface of a neck finish of the preform.

7. A mold assembly for molding a preform, comprising:
a first mold half having an elongated molding assembly for molding an interior portion of a preform, the elongated molding assembly having a first portion and a second portion, the first portion defines a first molding surface and the second portion defines a second molding surface;
a second mold half having a cavity molding surface;
a mold temperature control system; and
a mold cavity defined by the first portion, the second portion, and the cavity molding surface, wherein the mold temperature control system is configured to actively maintain the first portion at a temperature for forming crystalline material while actively maintaining the second portion at another temperature for forming amorphous material.

8. The mold assembly of claim 7, wherein the mold temperature control system comprises a first temperature control system and a second temperature control system, and the first temperature control system is independent of the second temperature control system.

9. The mold assembly of claim 8, wherein the first temperature control system is configured to maintain the first molding surface at the temperature for forming crystalline material and the second temperature control system is configured to maintain the second molding surface at the temperature for forming amorphous material, the temperature for forming crystalline material is greater than the crystallinity temperature of the material forming the preform, and the temperature for forming amorphous material is less than the crystallinity temperature of the material forming the preform.

10. The mold assembly of claim 7, wherein the first portion is positioned to form an interior surface of a neck finish of the preform.

11. The mold assembly of claim 7, wherein the second portion is positioned to form an interior surface of a body portion of the preform.

12. The mold assembly of claim 7, wherein the first portion and the second portion form a mandrel configured to form an interior portion of the preform.

13. The mold assembly of claim 7, wherein the elongated molding assembly comprises a core holder and a core that extends from the core holder, and the core holder comprises the first portion that extends along and surrounds a portion of the core.

14. A mold assembly for molding a preform with a crystalline neck finish, comprising:
a core section having an elongated molding assembly for molding an interior portion of a preform, the elongated molding assembly having a neck finish molding portion and a body molding portion;
a cavity section having a cavity molding surface;
at least one temperature control system; and
a mold cavity defined by the neck finish molding portion, the body molding portion, and the cavity molding surface, the at least one temperature control system is configured to actively maintain the neck finish molding portion at a temperature for forming crystalline material while actively maintaining the body portion at another temperature for forming amorphous material.

15. A method of making a preform, comprising:
injecting a material into a cavity formed by a mold section and a core section, the core section comprises a core neck finish portion for molding an inner surface of a preform and a core body portion for molding another inner surface of the preform;
maintaining the core neck finish portion at a first temperature and the core body portion at a second temperature, wherein the first temperature is greater than the crystallinity temperature of the material and the second temperature is less than the crystallinity temperature of the material; and
leaving the material in contact with the core section to form a preform having a body portion that is primarily amorphous or semi-crystalline and a neck finish that is primarily crystalline.

16. The method of claim 15, further comprising rapidly cooling the preform after a target amount of crystallization.

17. The method of claim 16, wherein a substantial portion of the heat absorbed by the core neck finish portion is transferred to a first temperature control system during the cooling of the preform.

18. The method of claim 17, wherein the core body portion absorbs heat from the preform, a substantial portion of the heat absorbed by the core body portion is transferred to a second temperature control system that operates independently of the first temperature control system.

19. The method of claim 15, further comprising:
placing the preform in a second mold;
injecting a second layer of material over the body portion of the preform to form a two-layer preform; and
removing the two-layer preform from the mold.
